(19) United States
(12) Patent Application Publication
(10) Pub. No.: US 2013/0050718 A1
(43) Pub. Date: Feb. 28, 2013

(54) IMAGE FORMING APPARATUS

(71) Applicants: Atsushi TAKAHASHI, Tokyo (JP); Kenji IZUMIYA, Tokyo (JP); Hiroshi OYAMA, Tokyo (JP); Yumiko IZUMIYA, Tokyo (JP)

(72) Inventors: Atsushi TAKAHASHI, Tokyo (JP); Kenji IZUMIYA, Tokyo (JP); Hiroshi OYAMA, Tokyo (JP); Yumiko IZUMIYA, Tokyo (JP)

(73) Assignee: KONICA MINOLTA BUSINESS TECHNOLOGIES, INC., Tokyo (JP)

(21) Appl. No.: 13/596,728

(22) Filed: Aug. 28, 2012

(30) Foreign Application Priority Data
Aug. 31, 2011 (JP) 2011-189419

(51) Int. Cl. G06K 15/02

(52) U.S. Cl. 358/1.5

(57) ABSTRACT

An image forming apparatus contains a transporting unit for transporting a sheet of paper to an image forming section, a deviation detection sensor which detects a passing position of the transported sheets of paper end outputs passing data of the transported sheets of paper for every sheet of paper, a deviation calculation section which generates deviation storage data for evaluating a condition of a transporting section or a detection section by performing statistical processing on the passing data of the transported sheets of paper, and a discrimination section which discriminates between a case in which there is malfunction in the transporting section and a case in which there is malfunction in the detection section by comparing the deviation storage data with deviation characteristics data for discriminating between the malfunction in the transporting section and the malfunction in the detection section.

### CROSS REFERENCE TO RELATED APPLICATION

The present invention contains subject matter related to Japanese Patent Application JP 2011-189419 filed in the Japanese Patent Office on Aug. 31, 2011, the entire contents of which being incorporated herein by reference.

### BACKGROUND OF THE INVENTION

1. Field of the Invention

The present invention relates to an image forming apparatus that forms an image on a sheet of paper and which is applicable to a monochrome or color printer, a copy machine, a multiple function machine and the like.

2. Description of Related Art

A color printer that forms a color image on a sheet of paper based on color image information, a color copy machine equipped with a scanning function to read an image on a manuscript and output an image signal for reproducing a color image and a multiple function machine have been often used in recent years. For example, a digital color copy machine which reads a color image on the manuscript, obtains items of image data of red (R), green (G) and blue (B) and forms an color image on the sheet of paper based on these items of image data has been widely used.

In such a color copy machine, a color image forming apparatus adopting an electrographic system is equipped. The color image forming apparatus forms color toner images based, on items of image data for yellow (Y), magenta (M), cyan (C) and black (BK) after the items of the image data of RGB have been changed into items of image data for these colors. The image forming apparatus is provided with image-forming units respectively performing the image-forming output functions of Y, M, C and BK. The image forming apparatus forms latent images based on the image data on photosensitive drums around, the surface oil which charging portions charge static charges uniformly for every image color of Y, M, C and BK by writing units each using a polygon mirror.

Developing devices then develop the latent images for every image color. The image forming apparatus performs these charging, exposing and developing, overlaps the color toner images formed on the surfaces of the photosensitive drums 1 by using toner on, for example, an intermediate transfer belt and transfers the overlapped color toner images to a sheet member (hereinafter, also referred to as “a sheet of paper”) by a transfer portion. A fixing portion fixes the toner image transferred to the desired sheet of paper. Thus, the image forming apparatus forms the color image on the desired sheet of paper based on the image data.

On the other hand, another image forming apparatus is equipped with deviation correction functions of the sheet of paper. According to these deviation correction functions of the sheet of paper, a deviation detection sensor detects a position of a transported sheet of paper for every sheet of paper. An amount of deviation between a transport reference position fixed on every size of sheet of paper and an actually detected position of the transported sheet of paper is corrected on a direction that is perpendicular to the transporting direction of sheet of paper (hereinafter; also referred to as “main scanning direction”). Thus, the image forming apparatus corrects the image writing position to make stable the image position on the sheet of paper. It is to be noted that when detecting an amount of deviation exceeding a predetermined amount, the image forming apparatus determines that there is a strong possibility that a deviation detection sensor detects it by mistake based on any influence of paper powder or the like so that the image forming apparatus does not perform any deviation correction functions of the sheet of paper.

Further, an image forming apparatus equipped with automatic paper inversion and transporting mechanism (Auto Duplex Unit: hereinafter; referred to as “ADU inversion unit”) and having a duplex printing mode in which monochrome or color images are formed on both surfaces of the sheet of paper has been also used. According to the deviation correction functions of the sheet of paper in the image forming apparatus (duplex color printer) having the duplex printing mode, the image forming apparatus detects a deviation of the sheet of paper in a paper inversion and transporting path after a print has been performed on a surface of sheet of paper and calculates an amount of the deviation of the sheet of paper in regard to the transport reference position of sheet of paper during the duplex printing mode. In order to avoid any influence Py the amount of deviation, the image forming apparatus corrects the image writing position on the main scanning direction of image-supporting member during a formation of image on a back surface the sheet of paper. These deviation correction functions of the sheet of paper have been often installed in an image forming apparatus which is capable of being equipped with a large external paper feeder, and a monochrome rapid printer in addition of the duplex color printer.

In connection with a color copy machine which can determine exchange timing of the intermediate transfer belt, Japanese Patent Application Publication ho. 2010-020249 has disclosed an image forming apparatus. This image forming apparatus is provided with the intermediate transfer belt, an optical sensor, control means and recording means. The optical sensor is set on a position which can see through the intermediate transfer belt, and detects reflected light on the toner image supported by the intermediate transfer belt. The control means controls the optical sensor to acquire any reflection information distribution along a rotation direction of the intermediate transfer belt when turning on a power supply or a front door is shut (during no-image forming period of time). The recording means records reflection information distribution that the optical sensor acquired. The reflection information distribution is acquired from sensor output of one round of the intermediate transfer belt. Based on the reflection information distribution, a profile indicating a situation of a surface of the intermediate transfer belt can foe created.

On the assumption of them, the control means compares the reflection information distribution now acquired by the optical sensor with the reflection information distribution recorded in the recording means. When the reflection information distribution acquired by the optical sensor does not correspond to the reflection information distribution recorded in the recording means, the control means determines that the intermediate transfer belt is exchanged and carries out any control following the exchange of intermediate transfer belt.

### SUMMARY OP THE INVENTION

However, the past image forming apparatus, which was equipped with deviation correction functions of the sheet of paper, has following issues:

(1) When there is a poor setting of a feeding tray, for example, the feeding tray is set up with it being deviated over a predetermined amount of deviation, the deviation correction functions of the sheet of paper fail. Accordingly, a user finds that any poor image position on the sheet of paper is based on the poor setting of the feeding tray from a condition of a printed-out sheet of paper.

(2) When the position of the transported sheet of paper exceeds the predetermined amount of deviation based on any transport deviations on the main scanning direction, of the transported sheet of paper even if the feeding tray is normally set near the predetermined value, the deviation correction functions of the sheet of paper which are primarily required fail. In this case, the image position is shifted from, a fixed position on the sheet of paper so that the user also finds that this is based on the poor setting of the feeding tray from a condition of a printed-out sheet of paper, which is similar to the above-mentioned issue (1).

(3) When the position of the transported sheet of paper does not exceed the predetermined amount of deviation and the feeding tray is normally set near the predetermined value, the deviation correction functions of the sheet of paper is operable. Accordingly, the image position is correctly set on a fixed position on the sheet of paper so that the image position is not shifted. However, when the above-mentioned issue (2) and the above-mentioned normal condition, are irregularly repeated, the use fails to understand which the above-mentioned issue (2) is based on the poor setting of the feeding tray or based on any error detection by a sensor.

(4) Particularly, an optical sensor of reflection type is used as a deviation detection sensor and a coated sheet metal is used on an opposite surface thereof, a surface of the coated sheet metal may be peeled off by any friction of sheets of paper. Even, when, a resin flat board is used on the opposite surface thereof, reflectance of the opposite surface thereof may rise based on paper powders, toner components and wax components contained in the toner and the like. In these cases, detection precision on the position of the transported sheet of paper has been deteriorated.

Accordingly, it is difficult for the user to specify malfunction such as poor adjustment in setting position of the transporting section for the sheets of paper or the error detection by the detection portion for the sheet of paper. Accordingly, even when introducing the profile-creating technology disclosed in Japanese Patent Application Publication No. 2010-020249 thereinto, it is difficult for the user to determine which there is malfunction in the transporting section for the sheets of paper or in the detection portion for the sheet of paper.

This invention solves the above-mentioned issues and it is desirable to provide an image forming apparatus that can accurately discriminate between a case in which there is malfunction in the transporting section for the sheet of paper and a case in which there is malfunction in the detection portion for the sheet of paper.

To solve at least one of the above-mentioned issues, an image forming apparatus reflecting one aspect of the present invention contains; an image forming section which forms the image on the sheet member, a transporting section which transports the sheet member to the image forming section, a detection section which detects a passing position of transported sheet member on a direction that is perpendicular to a transporting direction of the sheet member and outputs information on the passing position for every transported sheet member, an evaluation information-generating section which generates evaluation information for evaluating a condition, of the transporting section or the detection section by performing statistical processing on an amount of a deviation for every sheet member, the deviation being a difference between the passing position of the transported sheet member based on the information on the passing position output from the detection section and a transport reference position on the direction that is perpendicular to the transporting direction of the sheet member, and a discrimination section configured to discriminate between a case in which there is malfunction in the transporting section and a case in which there is malfunction in the detection section by comparing the evaluation information generated in the evaluation-information-generating section with evaluation reference information that is a reference when discriminating between the case in which there is the malfunction in the transporting section and the case in which there is the malfunction in the detection section.

According to the image forming apparatus reflecting one aspect; of the present invention, the transporting section transports the sheet member to the image forming section. The detection section detects the passing position of transported sheet member on the direction that is perpendicular to the transporting direction of the sheet member and outputs information on the passing position to the evaluation-information-generating section for every transported sheet member. The evaluation-information-generating section generates evaluation information for evaluating a condition of the transporting section or the detection section by performing statistical processing on an amount of a deviation for every sheet member. The deviation is a difference between the passing position of the transported sheet member based on the information on the passing position output from the detection section and the transport reference position on the direction that is perpendicular to the transporting direction of the sheet member. On the assumption of them, the discrimination section is configured to discriminate between a case in which there is malfunction in the transporting section and a case in which there is malfunction in the detection section by comparing the evaluation information generated in the evaluation-information-generating section with evaluation reference information that is a reference when discriminating between the case in which there is the malfunction in the transporting section and the case in which there is the malfunction in the detection section.

For example, it is desirable to provide the image forming apparatus wherein the evaluation information includes an average value which is obtained by averaging the amount of deviation for every sheet member and the evaluation reference information includes a reference value in relation to the average value which is obtained by averaging the amount of deviation for every sheet member.

It is also desirable to provide the image forming apparatus further containing a warning section which warns the malfunction discriminated by the discrimination section, wherein the warning section warns that there is the malfunction in the transporting section when the average value which is obtained by averaging the amount of deviation for every sheet member exceeds the reference value.

it is further desirable to provide the image forming apparatus wherein the evaluation information includes a standard deviation value of the amount of deviation for every sheet member and the evaluation reference information includes a reference value in relation to the standard deviation value of the amount of deviation for every sheet member.

It is additionally desirable to provide the image forming apparatus further containing a warning section which warns the malfunction discriminated by the discrimination section, wherein the warning section warns that there is the malfunction in the detection section when the standard deviation value of the amount of deviation for every sheet member exceeds the reference value.

It is still further desirable to provide the image forming apparatus wherein the reference information includes different species of the reference information for every size of the sheet member, every kind of the sheet member or every paper weight of the sheet member.

It is additionally desirable to provide the image forming apparatus further containing a correction section which corrects an image writing position in the image forming section, wherein the correction section, corrects the image writing position in the image forming section when the amount of the deviation for every sheet member, the deviation being the difference between the passing position of the transported sheet member based on the information on the passing position output from the detection section and the transport reference position on the direction that is perpendicular to the transporting direction of the sheet member, stays within a permissible range of a correction operation by the correction section.

The concluding portion of this specification particularly points out and directly claims the subject matter of the present invention. However, those skilled in the art will best understand both the organization and method of operation of the invention, together with further advantages and objects thereof, by reading the remaining portions of the specification, in view of the accompanying drawing (s) wherein like reference characters refer to like elements.

### BRIEF DESCRIPTION OF THE DRAWINGS

FIG. 1 is a diagram of a color copy machine as an embodiment of this invention for showing a configuration example thereof;

FIG. 2 is a diagram of an ADU inversion unit seen from a front thereof for showing an arrangement example of a deviation detection sensor and a black color board;

FIG. 3 is a diagram showing a detection example of a side edge of a sheet of paper by a deviation detection sensor;

FIG. 4 is a block diagram, of a control section of the color copy machine according to a first embodiment of this invention for illustrating a configuration example thereof;

FIG. 5 is a graph showing a generation example of a histogram when evaluating deviations of the sheets of paper;

FIG. 5 is a graph showing an evaluation example (Part one) of the histogram in a discrimination section;

FIG. 7 is a graph showing an evaluation example (Part two) of the histogram in the discrimination section;

FIGS. 8A and 8B are graphs each showing an evaluation example (Part three) of the histogram in the discrimination section;

FIG. 9 is a graph showing an evaluation example (Part four) of the histogram in the discrimination section;

FIGS. 10A and 10B are graphs each showing an evaluation example (Part five) of the histogram in the discrimination section;

FIG. 11A is a table showing a storage example of passing data of transported sheets of paper stored in a measured-data-storing section and FIG. 11B is a table showing a storage example of stored deviation data of transported sheets of paper stored in the measured-data-storing section;

FIG. 12 is a table showing a storage example (Part one) of deviation characteristics data stored in a characteristics data storing section;

FIG. 13 is a table for showing a storage example (Part two) of deviation characteristics data stored in the characteristics data storing section;

FIG. 14 is a flowchart showing an operation example (Part one) of the color copy machine when performing statistical processing;

FIG. 15 is a flowchart showing an operation example (Part two) of the color copy machine when performing statistical processing;

FIG. 16 is a block diagram of a control section of a color copy machine according to a second embodiment of this invention for illustrating a configuration example thereof;

FIG. 17 is a flowchart showing an operation example of a color copy machine according to a third embodiment of this invention when performing statistical processing; and

FIG. 18 is a flowchart showing an operation example of a color copy machine according to a fourth embodiment of this invention when performing statistical processing.

### DESCRIPTION OF THE PREFERRED EMBODIMENTS

The following will describe embodiments of an image forming apparatus relating to the invention with reference to drawings, it is to be noted that the following description of the embodiments does not limit claims, which will be described later, or a meaning of each term thereof.

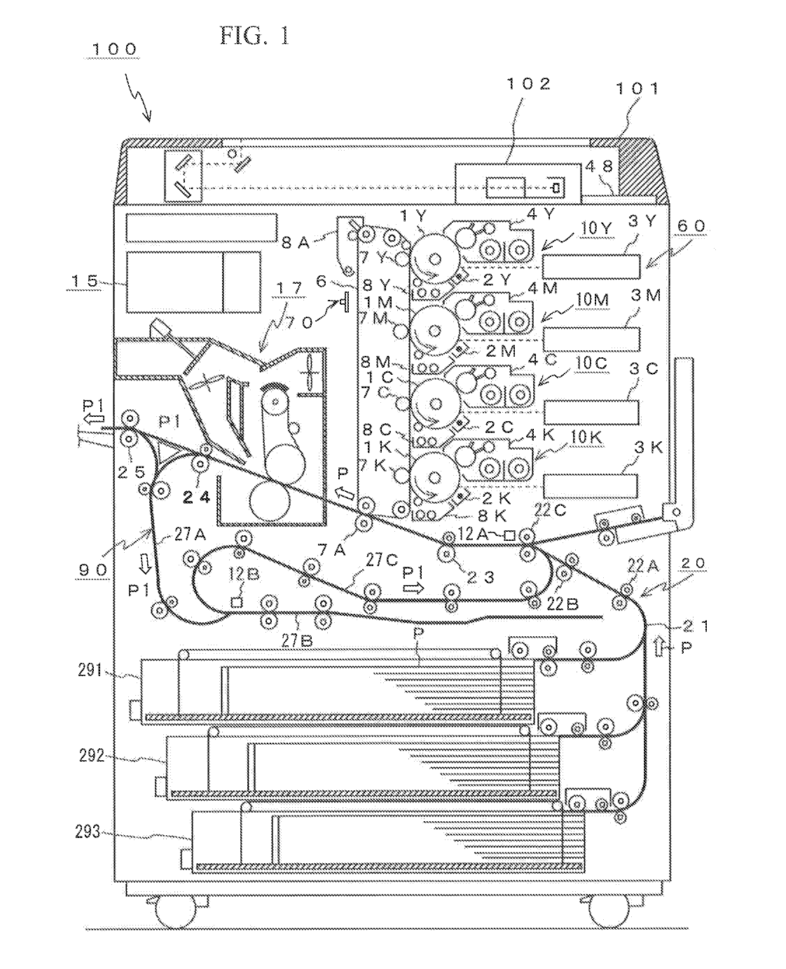

FIG. 1 schematically shows an outline configuration example of a color copy machine 100 constituting an example of an image forming apparatus according to a first embodiment of this invention. The color copy machine 100 contains a color copy machine main body 101. The color cony machine main body 101 is provided with an electrographic image forming portion 60 of tandem type and an automatic paper inversion and transporting unit (Auto Duplex Unit; hereinafter, referred to as “ADU inversion unit 90”; at an almost middle thereof.

The color copy machine main body 101 is also provided with an intermediate transfer belt 6, deviation detection sensors 12A, 12B, a whole control section 15, a fixing unit 17, a manipulation section 48 and an image reading apparatus 102 in addition to the image forming portion 60 and the ADU inversion unit 90.

The image reading apparatus 102 is arranged at upper portion of the color copy machine main body 101. The image reading apparatus 102 scans and exposes a manuscript mounted, on a manuscript holder using an optical system of a scanning and exposure apparatus and reads an image using a line image sensor. An image processing section, not shown, performs analog processing, analog/digital conversion processing (hereinafter, referred to as “A/D conversion processing”), shading processing, image compression processing and the like on an image information signal which has been photoelectrically converted in the image reading apparatus 102. A writing unit of the image forming portion 60 then receives the image information signal.

The image forming portion 60 forms toner images having desired densities on the intermediate transfer belt 6 which has a belt surface and is movable at a predetermined speed. The image forming portion 60 contains an image forming unit 10Y which forms an yellow image (Y), an image forming unit 10M which forms a magenta image (M), an image forming unit 10C which forms a cyan image (C) and an image forming unit 10K which, forms a black image (K). In this embodiment, the common functions concerning colors are indicated by Y, M, C and K, which respectively show colors to be formed, following a number, for example, 10.

The image forming unit 10Y contains a photosensitive drum 1Y, a charging portion 2Y which is arranged around the photosensitive drum 1Y, a writing unit 3Y, a developing unit 4Y and a cleaning portion 8Y.

The image forming unit 10M contains a photosensitive drum 1M, a charging portion 2M which is arranged around the photosensitive drum 1M, a writing unit 3M, a developing unit 4M and a cleaning portion 8M.

The image forming unit 10C contains a photosensitive drum 1C, charging portion 2C which is arranged around the photosensitive drum 1C, a writing unit 3C, a developing unit 4C and a cleaning portion 8C.

The image forming unit 10K contains a photosensitive drum 1K, a charging portion 2K which is arranged around the photosensitive drum 1K, a writing unit 3K, a developing unit 4K and a cleaning portion 8K.

The respective photosensitive drums 1Y, 1M, 1C and 1K, the charging portions 2Y, 2M, 2C and 2K, the writing units 3Y, 3M, 3C and 3K, the developing units 4Y, 4M, 4C and 4K and the cleaning portions 8Y, 8M, 8C and 8K in the image forming units 10Y, 10M, 10C and 10K have the respectively common configurations. They will be described with Y, M, C and K being omitted except for any cases in which they are required to foe distinguished.

In the image forming units 10, the charging portions 2 charge a static charge uniformly around surfaces of the photosensitive drums 1. Each of the writing units 3 is composed of, for example, a laser scanning exposure device of polygon mirror type. The writing units 3 scan the surfaces of the photosensitive drums 1 using laser beam based on the image data of each image color and operate so as to write the image data on the surfaces of the photosensitive drums 1 for every line. On the photosensitive drums 1, latent images are respectively formed by the laser beam scanned using polygon mirrors. The developing units 4 develop the latent images formed on the surfaces of she photosensitive drums 1 by using toners. This enables toner images, which are visual images, to be formed on the photosensitive drums 1.

In the image forming portion 60, the yellow image (Y), the magenta image (M), the cyan image (C) and the black image (K) are respectively formed on the photosensitive drums 1Y, 1M, 1C and 1K of the image forming units 10Y, 10M, 10C and 10K. The toner images of respective colors formed on the photosensitive drums 1Y, 1M, 1C and 1K are transferred to the intermediate transfer belt 6 by driving primary transfer rollers 7Y, 7M, 7C and 7K corresponding to the photosensitive drums 1 of respective colors Y, M, C and K (primary transfer).

The intermediate transfer belt 6 has an endless belt. The photosensitive drums 1Y, 1M, 1C and 1K respectively transfer the toner images to the intermediate transfer belt 6. The intermediate transfer belt 6 is stretched across plural rollers so as to be able to run around them. By moving the intermediate transfer belt 6 on a clockwise direction, the color images formed on the intermediate transfer belt 6 are transported toward a secondary transfer portion 7A. The secondary transfer portion 7A is arranged below the image forming portion 60 and at the lowest position of the intermediate transfer belt 6.

A feeder unit 20 is arranged below the image forming portion 60 and feeds a sheet member (hereinafter, referred to as “sheet of paper P”) to the image forming portion 60. The sheet of paper P contains plain paper, thin paper, thick paper and coated paper of predetermined sizes. The feeder unit 20 is provided with plural feeding trays 291, 292 and 293. The feeding trays 291, 292 and 293 respectively contain sheets of paper P having a predetermined size, a predetermined kind of paper and a predetermined paper weight. A first feeder 21 feeds the sheet of paper P from any of the feeding trays 291, 292 and 293 to the secondary transfer portion 7A through the conveying rollers 22A, 22B and 22C and the registration rollers 23.

The secondary transfer portion 7A transfers the toner images formed on the intermediate transfer belt 6 all together from, the intermediate transfer belt 6 to the sheet of paper P (secondary transfer). The fixing unit 17 is positioned at a downstream side of the secondary transfer portion 7A and performs fixing processing on a sheet of paper P (hereinafter, referred to as “image-recording paper P1”) on which the color image is transferred. The image-recording paper P1 fixed by the fixing unit 17 is ejected by paper ejection rollers 25 through fixing and transporting rollers 24 outside the apparatus.

The color copy machine 100 is provided with the ADU inversion unit 90. Corresponding to user's setting of a simplex printing mode or a duplex printing mode, the color copy machine 100 transports the fixed image-recording paper P1 from the fixing and transporting rollers 24 to the ADU inversion unit 90 which inverts the fixed image-recording paper P1 from the front thereof to the back thereof or vice reverse and ejects the image-recording paper P1 or forms an image on a back surface of the image-recording paper P1, namely, performs duplex printing on the sheet of paper P. Here, the simplex printing mode is referred to as an operation to form an image on one side of a sheet of paper P (sheet member). The duplex printing mode is referred to as an operation to form images on both sides of a sheet of paper P.

The cleaning portions 8Y, 8M, 8C and 8K are provided below the respective photosensitive drums 1 so that they respectively correspond to the photosensitive drums 1Y, 1M, 1C and 1K. The cleaning portions 8Y, 8M, 8C and 8K remove (clean) any toner materials remained in the photosensitive drums 1Y, 1M, 1C and 1K after former writing has been carried out. A cleaning portion 8A is provided at an upper portion of the intermediate transfer belt 6 and cleans any toner materials remained in the intermediate transfer belt 6 after the secondary transfer.

The deviation detection sensor 12A constituting the detection section and corresponding to the simplex printing mode (side 1) is arranged between the transporting rollers 22C and the registration rollers 23 and at a downstream side of the transporting rollers 22C (before the registration rollers 23). The deviation detection sensor 12B corresponding to the duplex printing mode (side 2) is also arranged in the ADU inversion unit 90. The deviation detection sensor 12A detects a passing position of the transported sheet of paper P fed from the feeder unit 20 or an external feeder, not shown, and generates a detection signal of the passing position of the transported sheet of paper. The deviation detection sensor 12B positioned in the ADU inversion unit 90 detects a passing position of the transported image-recording paper P1 which is inverted from the front thereof to the back thereof and generates a detection signal of the passing position of the transported image-recording paper P1. Both detect a passing position of the transported sheet of paper P and a passing position of the transported image-recording paper P1 for correcting an image writing position based on the amount of the deviation which is a difference between the passing position of the transported sheet of paper P or the transported image-recording paper P1 and the transport, reference position of the transported sheet of paper P or the transported image-recording paper P1 on the direction that is perpendicular to the transporting direction of the transported sheet of paper P or the transported image-recording paper P1. These members constitute the color copy machine 100.

It is to be noted that in a monochrome copy machine, the deviation detection sensor 12B corresponding to the duplex printing mode (side 2) is omitted and the deviation detection sensor 12A corresponding to the simplex printing mode (side 1) performs also any detection operations in the duplex printing mode. In this case, one deviation detection sensor 12A is arranged in the feeder unit 20 or near an outlet of the feeder unit 20 because suet a deviation detection sensor 12A can carry out the data correction in a short time.

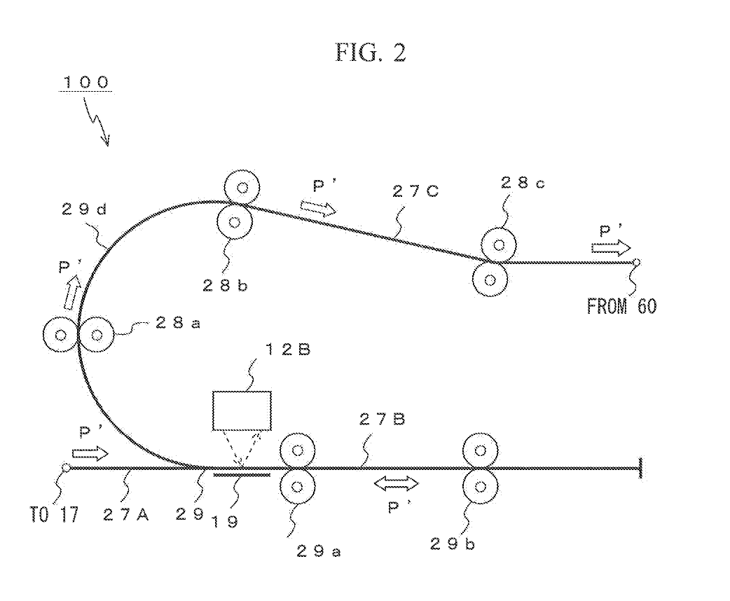

The following will describe an arrangement example of the deviation detection sensor 12B and a black color board 19 in the ADU inversion unit 90 with reference to FIG. 2. The ADU inversion unit 90 shown in FIG. 2 contains a re-feeding circulation path 27A, an inverting path 27B, a re-feeding path 27C, the deviation detection sensor 12B, the black color board 19 and a path-switching portion 29. The re-feeding circulation path 27A is arranged at a downstream side of the fixing unit 17 as shown in FIG. 1 and the inverting path 27B is arranged at a downstream side of the re-feeding circulation path 27A. The inverting path 27B is used for a switchback path (sheet-waiting path) in which the image-recording paper P1, on a first surface (front surface) of which an image has been already formed, is introduced thereinto and a transporting direction of the image-recording paper P1 is inverted when setting the duplex printing mode.

The inverting path 27B includes inverting rollers 29a, loop rollers 29b and a linear portion. The inverting rollers 29a are rotatably driven by a motor, not shown, and inverts the image-recording paper P1 received from the re-feeding circulation path 27A to transport the image-recording paper P1 so as to push it upward from the inverting path 27B toward the re-feeding path 27C. The loop rollers 29b operate s make a forward end of the image-recording paper P1 come into contact with a nipped, positron of the inverting rollers 29a by receiving any rotation force of a motor, not shown, when inverting the image-recording paper P1.

The re-feeding path 27C is arranged below the secondary transfer portion 7A as shown in FIG. 1 and almost above the inverting path 27B. At a diverging point between the re-feeding circulation path 27A and the inverting path 27B, the path-switching portion 29 is provided. The path-switching portion 29 switches the transporting paths when carrying out the duplex printing mode so as to select the re-feeding circulation path 27A or the re-feeding path 27C. This path-switching portion 2S enables the inverting path 27B to be timely passed to any one of the re-feeding circulation path 21A and the re-feeding path 27C.

The re-feeding path 27C includes conveying rollers 28a through 28c and a U-turn guide portion 29d. The re-feeding path 27C timely passes to the inverting path 27B and re-feeds the image-recording paper P1 to the image forming portion 60 after it is inverted in the inverting path 27B. The U-turn guide portion 29d is constituted of a sheet-transporting path having a circular arc shape. The U-turn guide portion 29d extends upward from the linear portion of the inverting path 27B like a circular arc. The conveying rollers 28a through 26c transport the image-recording paper P1, which has been transported from the inverting path 27B to the re-feeding path 27C by the inverting rollers 29a, on the re-feeding path 27C toward a predetermined direction.

In this embodiment, the deviation detection sensor 12B is provided near the path-switching portion 29. In the other words, the deviation detection sensor 12B is provided between the path-switching portion 29 and the inverting rollers 29a on the inverting path 27B. Providing the deviation detection sensor 12B at this position is because it is necessary to detect an amount of deviation of the image-recording paper P1 at an early stage when setting the duplex printing mode since a lot of time is required for any data correction.

The deviation detection sensor 12B contains an optical detection element of reflection type. The black color board 19 for absorbing light is provided at a side opposite to the optical detection element. The black color board 19 is a metal plate to which black matte lacquer is applied. The deviation detection sensor 12B detects a passing position of a side edge of each of the transported sheets of image-recording paper P1 which are transported on the inverting path 27B by the inverting rollers 29a when setting the duplex printing mode. The passing position is an amount of a deviation which is a difference between the passing position of the transported image-recording paper P1 and a transport reference position on the direction that is perpendicular to the transporting direction of the image-recording paper P1. The deviation detection sensor 12B then outputs information on the passing position for every transported image-recording paper P1. For the deviation detection sensor 12B, for example, an image sensor of close contact type having resolution of 200 dpi and a length of B5 size is used.

The deviation detection sensor 12A arranged between the conveying rollers 22C and the registration rollers 23, as shown in FIG. 1, and at a downstream side of the conveying rollers 22C (before the registration rollers 23) has a configuration similar to the above-mentioned configuration of the deviation detection sensor 12B, a detailed description of which will be omitted.

According to such configurations of the deviation detection sensors 12A and 12B, the deviation defection sensor 12A detects the amount of the deviation of the sheet of paper P in the feeder unit 20 when setting the simplex printing mode. The deviation detection sensor 12B detects the amount of the deviation of the image-recording paper P1 in the ADU inversion unit 90 when setting the duplex printing mode. The whole control section 15 corrects a writing position of the image when forming the image on one side of the sheet of paper or forming the image on the other side of the sheet of paper on the basis of the amount of the deviation of the sheet of paper P or the image-recording paper P1.

Further, any statistical processing is performed on the information on the passing position for every transported sheet of paper P or every transported image-recording paper P1 (hereinafter, referred to as “passing position data D12” of the transported sheets of paper P or the image-recording paper P1). A histogram in which a vertical axis represents a frequency of occurrence and a horizontal axis represents an amount of deviation ε(t) is generated. By this histogram, it is possible to compare evaluation information for evaluating a condition of the sheets of paper P or the image-recording paper P1 in the transporting section or a condition of the detection section with evaluation reference information that is a reference for specifying the case in which there is malfunction on the sheets of paper P or the image-recording paper P1 in the transporting section or the case in which there is malfunction of the detection section.

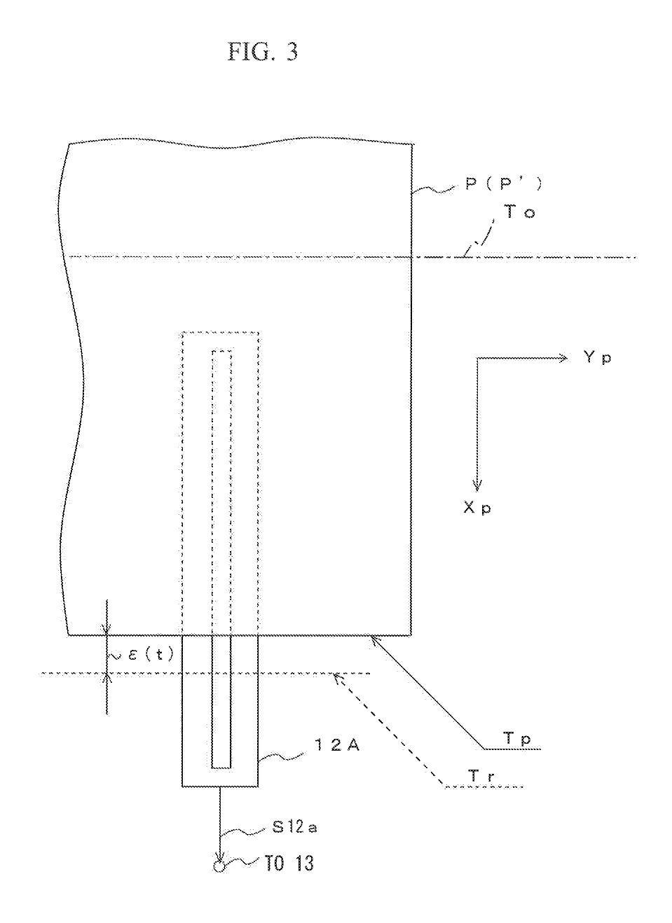

The following will describe a detection example of a side edge of the sheet of paper P by the deviation detection sensor 12A with reference to FIG. 3. In FIG. 3, Yp represents a transporting direction of the sheet of paper P (auxiliary scanning direction); and Xp represents a direction that is perpendicular to the transporting direction Yp of the sheet of paper P (main scanning direction). The deviation detection sensor 12A is arranged so that its longitudinal direction is positioned along the direction Xp. The deviation detection sensor 12A detects a passing position of a side edge of each of the transported sheets of paper P on the main scanning direction.

In FIG. 3, symbols, “To” represent a center reference position when transporting the sheet of paper P and a center (middle) position of the transporting path, not shown, of the sheet of paper P on the main scanning direction, which is set along the transporting direction Yp of the sheet of paper P (a center reference of the transporting path). Symbols, “Tr” represent a transport reference position on the main scanning direction that is perpendicular to the transporting direction Yp of the sheet of paper P. The transport reference position Tr is a position away from the center reference position Tr by a predetermined distance. As the transport reference position Tr, different values are set based on the sizes of sheets of paper P. The transport reference position Tr is a target control position which is set so that the side edge of the sheet of paper P passes therethrough, based on the center reference position To. Symbols, “Tp” represent a passing position of the transported sheet of paper P, which is a position through which the side edge of the sheet of paper P really passes on the deviation detection sensor 12A.

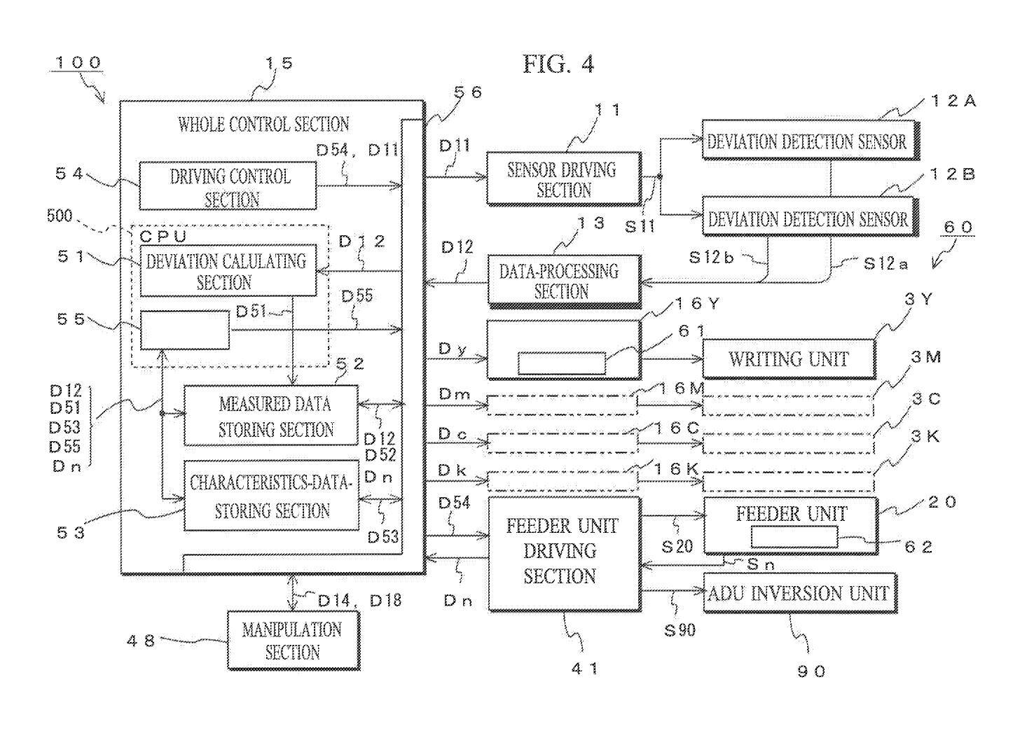

Symbols, “ε(t)” represent the amount of deviation and a difference between the passing position Tp of the transported sheet of paper P and the transport reference position Tr. When the side edge of the sheet of paper P passes through the transport reference position Tr, the amount of deviation ε(t), namely, the difference between the passing position Tp of the transported sheet of paper P and the transport reference position Tr becomes zero. The deviation detection sensor 12A detects the amount of deviation ε(t) in μm units. The deviation detection sensor 12A detects the passing position of the side edge of each of the sheets of paper P fed by the feeder unit 20 as shown in FIG. 1 and generates information on the passing position (hereinafter referred to as “passing position detection signal S12a”) for every transported sheet of paper P. The deviation detection sensor 12A outputs the passing position detection signal S12a to a data-processing section 13 shown in FIG. 4. It is to be noted that the deviation detection sensor 12B performs the operations similar to the above-mentioned operations of the deviation detection sensor 12A, a detailed description of which will be omitted.

### First Embodiment

The following will describe a configuration example of a control section of the color copy machine 100 according to a first embodiment of this invention with reference to FIG. 4. The color copy machine 100 shown in FIG. 4 contains writing units 3Y, 3M, 3C and 3K, a sensor driving section 11, the deviation detection sensors 12A, 12B, a data-processing section 13, the whole control section 15, writing control sections 16Y, 16M, 16C and 16K, the feeder unit 20, a feeder unit driving section 41, a manipulation section 48 and the ADU inversion unit 90.

The whole control section 15 contains a deviation calculating section 51, a measured-data-storing section 52, a characteristics-data-storing section 53, a driving control section 54, a discrimination section 55 and an I/O interface 56. The sensor driving section 11 is connected, to the I/O interface 56. The sensor driving section 11 controls the deviation detection sensor 12A based on sensor driving data D11. For example, the sensor driving section 11 decodes the sensor driving data D11 to generate a sensor driving signal S11. The sensor driving section 11 outputs the sensor driving signal S11 to the deviation detection sensor 12A. The sensor driving data D11 includes data for controlling reading of the deviation detection sensor 12A and/or the brightness of a luminous body. The whole control section 15 outputs the sensor driving data D11 to the sensor driving section 11.

The sensor driving section 11 is connected to the deviation detection sensor 12A. The deviation detection sensor 12A detects a passing position of a side edge of each of the transported sheets of paper P fed from the feeder unit 20 at a downstream side of the conveying rollers 22C, and generates a detection signal S12a of the passing position of the transported sheet of paper for every sheet of paper P. The deviation detection sensor 12A outputs the detection signal S12a of the passing position of the transported sheet of paper to the data-processing section 13 based on the sensor driving signal S11.

The sensor driving section 11 is also connected to the deviation detection sensor 12B in addition to the deviation detection sensor 12A. The deviation detection sensor 12B detects a passing position of a side edge of each of the sheets of transported image-recording paper P1 transported and inverted in the ADU inversion unit 90 at a downstream side of the inverting rollers 29a, and generates a detection signal 312b of the passing position of the transported image-recording paper P1 for every sheet of image-recording paper P1. The deviation detection sensor 12B also outputs the detection signal S12b of the passing position of the transported image-recording paper P1 to the data-processing section 13 based on the sensor driving signal S11.

The data-processing section 13 is connected to the deviation detection sensors 12A and 12B. The data-processing section 13 receives the detection signal S12a of the passing position of the transported sheet of paper P from the deviation detection sensor 12A and performs any data processing, for example, binarization on the detection signal 512a to generate digital passing position data D12a of the transported sheets of paper P. Similarly, the data-processing section 13 receives the detection signal S12b of the passing position of the transported sheets of image-recording paper P1 from the deviation detection sensor 12B and performs any data processing on the detection signal S12b to generate digital passing position data D12b of the transported sheets of image-recording paper P1. Items of the digital passing position data D12a and D12b are separately output to the whole control section 15. In this embodiment, however, they are together described as passing position data D12. The whole control section 15 performs any statistical processing on the passing position data D12 so that the passing position data D12 become evaluation information (hereinafter, referred, to as “stored deviation data D52”) for evaluating a condition of the transporting section of the sheet of paper P or the detection section thereof.

The stored deviation data D52 contains data indicating an amount of deviation ε(t) generated between the passing position Tp of the transported sheet of paper P and the transport reference position Tr thereof and data Dn concerning the number of transported sheets of paper, which indicates a frequency of occurrence for every amount of deviation ε(t). The data-processing section 13 is connected to the I/O interface 56. The I/O interface 56 is then connected to the deviation calculating section 51, the measured-data-storing section 52, the characteristics-data-storing section 53 and the driving control section 54.

The deviation calculating section 51 and the measured-data-storing section 52 constitute an evaluation-information-generating section which generates a histogram in which a vertical axis represents a frequency of occurrence and a horizontal axis represents the amount of deviation ε(t) by performing statistical processing on the passing position data D12. This histogram is generated from the stored deviation data D52 and is used for evaluating a condition of the transporting section of the sheet of paper P or the detection section thereof. For the deviation calculating section 51, central processing unit (CPU), digital signal processor (DSP) and the like are used.

Here, an amount of deviation ε(t) is referred to as “a difference between the passing position Tp of the transported sheet of paper P, based on the passing position data D12 received from the data-processing section 13, and the transport reference position Tr of the transported sheet of paper P stored in the characteristics-data-storing section 53.” For example, the deviation calculating section 51 reads deviation characteristics data D53 indicating the transport reference position Tr of the transported sheet of paper P oat of the characteristics-data-storing section 53. The deviation calculating section 51 then calculates the amount of deviation ε(t) by calculating the difference between the passing position Tp of the transported sheet of paper P based on the passing position data D12 and the transport reference position Tr of the transported sheet of paper P. The calculated amount of deviation ε(t) between the passing position Tp of the transported sheet of paper P and the transport reference position Tr of the transported sheet of paper P corresponds to the data Dn concerning the number of transported sheets of paper, which indicates a frequency of occurrence, so that they constitutes the stored deviation data D52.

The measured-data-storing section 52 is connected to the deviation calculating section 51. The measured-data-storing section 52 stores the stored deviation data D52. In this embodiment, the histogram, is generated in which the vertical axis represents the frequency of occurrence and the horizontal axis represents the amount of deviation ε(t) based on the stored deviation data D52 obtained by performing statistical processing on the passing position data D12 of plural transported sheets of paper P. This enables the stored deviation data D52 for evaluating a condition of the sheet of paper P in the transporting section or the detection section thereof to be compared with reference information (hereinafter, referred to as “deviation characteristics data D53”) that is a reference for specifying a case in which there is malfunction of the sheet of paper P in the transporting section or a case in which there is malfunction in the detection section.

In this embodiment, a modulus of the histogram, generated in the deviation calculating section 51 and the measured-data-storing section 52 may be changed by a total number “n” of sheets of paper P to be transported and/or environmental information of the machine. The environmental information includes temperature and humidity in the machine.

According to the color copy machine 100, since the modulus of the histogram generated in the deviation calculating section 51 and the measured-data-storing section 52 may be changed by the total number of sheets of paper P to be transported and/or the environmental information of the machine, it is possible to calculate a deviation average value Ave, a standard deviation Std of the deviations of transported sheets of paper and the like as evaluation information, that is required to a self-maintenance function.

The characteristics-data-storing section 53 in addition to the measured-data-storing section 52 is connected to the I/O interface 56. The characteristics-data-storing section 53 stores the deviation characteristics data D53 for evaluating the stored deviation data D52 generated in the deviation calculating section 51. The deviation characteristics data D53 includes data for specifying a case in which there is malfunction of the sheet of paper P in the transporting section or a case in which there is malfunction in the detection section of the sheet of paper P. The deviation characteristics data D53 also includes data indicating the transport reference position Tr and deviation-evaluating information, respectively, for every size of sheet of paper P. Here, the deviation-evaluating information of the sheet of paper P is referred to as “the information for evaluating an extent of the deviation of the transported sheets of paper P on the basis of the transport reference position Tr”.

The deviation characteristics data D53 to be stored in the characteristics-data-storing section 53 may be changed and/or updated by setting transporting conditions of the sheet of paper which include sizes of sheets of paper P, kinds of sheets of paper P, paper weights of sheets of paper P and a specification of the feeding trays 291, 292 and 293. A user sets the transporting conditions of the sheet of paper P using she manipulation section 48. In this embodiment, since the deviation characteristics data D53 may be changed and/or updated by setting transporting conditions of the sheet of paper which include sizes of sheets of paper P, kinds of sheers of paper P, paper weights of sheets of paper P and a specification of the feeding trays 291, 292 and 293, it is possible to set a deviation average allowable value Pr, a reference standard deviation Ph of the deviations of transported sheets of paper and the like which are required to the self-maintenance function.

The discrimination section 55 is connected to the measured-data-storing section 52 and the characteristics-data-storing section 53. The discrimination section 55 receives the stored deviation data D52 for evaluating a condition of the sheet of paper P in the transporting section or the detection section thereof, which are generated in the deviation calculating section 51, and reads out of the characteristics-data-storing section 53 the deviation characteristics data D53 for specifying a case in which there is malfunction of the sheet of paper P in the transporting section or a case in which there is malfunction, in the detection section of the sheet of paper P. The discrimination section 55 then compares the stored deviation data D52 with the deviation characteristics data D53 to discriminate between a case in which there is malfunction in the transporting section and a case in which there is malfunction in the detection section.

Such discrimination processing allows specifying a case in which there is malfunction of the sheet of paper P in the transporting section or a case in which there is malfunction in the detection section of the sheet of paper P. For the discrimination section 55, CPU is used. Several CPUS may be respectively used for the deviation calculating section 51, the discrimination section 55 and the like while one CPU 500 may be used for different, purposes of calculation and discrimination.

The manipulation section 48 constituting a warning section is connected to the I/O interface 56. The manipulation section 48 warns that there is malfunction of the sheet of paper P in the transporting section or there is malfunction in the detection section of the sheet of paper P based on the discriminated result in the discrimination section 55. For example, the manipulation section 48 displays a warning, “Please check setting of feeding tray” when the deviation average value Ave is compared with the deviation average allowable value Pr in the discrimination section 55 and the deviation average value Ave exceeds the deviation average allowable value Pr.

Here, the deviation average value Ave is referred to as “an average value of the amounts of deviation ε(t) of the transported sheets of paper P with any deviations from the transport reference position Tr”. The deviation average allowable value Pr is referred to as “an allowable value for evaluating the deviation average value Ave”. When setting the deviation average allowable value Pr as an allowable region, the deviation average allowable value Pr includes the upper limit thereof and the lower limit thereof. In this embodiment, when the deviation average value Ave exceeds the upper limit of the deviation average allowable value Pr or falls down the lower limit of the deviation average allowable value Pr, the manipulation section 48 displays a warning, “Please check setting of feeding tray”, so that it is possible to provide nigh reliable color copy machine 100 having a self-maintenance function.

The manipulation section 48 displays a warning, “Please check deviation detection sensor” when the discrimination section 55 compares the standard deviation Std of the deviations of transported sheets of paper P with the reference standard deviation Ph of the deviations of transported sheets of paper P and the standard deviation Std exceeds the reference standard deviation Ph. Here, the standard deviation Std is referred, to as “a standard deviation of the deviations of the transported sheets of paper P with any deviations from the transport reference position Tr”. The reference standard deviation Ph is referred to as “information for evaluating the standard deviation Std of the deviations of the transported sheets of paper P”.

In this embodiment, when the standard deviation Std exceeds the reference standard deviation Ph, the manipulation section 48 displays a warning, “Please check deviation detection sensor” so that it is possible to provide high reliable color copy machine 100 having a self-maintenance function. For the manipulation section 48, for example, any touch-panel crystal liquid display device is used.

The driving control section 54 is connected to the above-mentioned I/O interface 56. The driving control section 54 outputs the sensor driving data D11 to the sensor driving section 11 to control the sensor driving section 11. The driving control section 54 outputs image data Dy to the writing control section 16f for yellow (Y) to control a yellow image formation. The driving control section 54 also outputs items of image data Dm, Dc and Dk to the writing control sections 16M, 16C and 16K for other colors (M, C, K) to control image formations for other colors (M, C, K).

It is to be noted that the writing control sections 16Y, 16M, 16C and 16K for colors (Y, M, C, K) in addition to the sensor driving section 11 and the data-processing section 13 are connected to the I/O interface 56. The writing unit 3Y for yellow color is connected to the writing control section 16Y.

In this embodiment, the writing control section 16Y is provided with a correction portion 61. The correction portion 61 corrects a writing start position of the yellow image in the writing unit 3Y based on a discriminated result of the discrimination section 55 (writing position correction). For example, when the discrimination section 55 compares the passing position Tp of the transported, sheet of paper P based on the passing position data D12 received from, the data-processing section 13 with, the maximum value Pmax of deviations based on the deviation characteristics data D53 and the passing position Tp falls down the maximum value Pmax of deviations, the correction portion 61 corrects the writing position thereof.

Here, the maximum value Pmax of deviations is referred to as “a value for evaluating whether or not the sheet of paper P is transported with it being deviated to the maximum, degree from the transport reference position Tr”. For example, the correction portion 61 corrects a writing start position of each color image so that a center position of an image to be formed is aligned with a center position of the sheet of paper on the main scanning direction, in order to avoid any influence of the amount of deviation ε(t). Similarly, other writing control sections 16M, 16C and 16K for colors (M, C, K) are respectively connected to the corresponding writing units 3H, 3C and 3K, and they are configured, so as to be the same as the writing control section 16Y, detailed description of which will be omitted.

In this embodiment, when the passing position Tp of the transported sheet of paper P based on the passing position data D12 thereof falls down the maximum value Pmax of deviations, the correction section 61 carries out writing corrections. Accordingly, when the passing position Tp of the transported sheet of paper P exceeds the maximum value Pmax of deviations based on the information on the passing position of the transported sheets of paper P, the correction section 61 does not carry out any writing corrections so that the machine can be smoothly shifted to the warning processing.

The feeder unit driving section 41 is also connected, to the I/O interface 56. To the feeder unit driving section 41, the feeder unit 20 and the ADU inversion unit 90 are connected. The feeder unit driving section 41 controls the feeder unit 20 and the ADU inversion unit 90 based on transport control data D54. The feeder unit 20, the ADU inversion unit 90 and the like constitute the transporting section.

The transport control data D54 is data for controlling the transport of the feeder unit 20 and the ADU inversion unit 90. The transport control data D54 is also data for transporting the sheet of paper P to a predetermined direction in the feeder unit 20 and for inverting the image-recording paper P1 in the ADU inversion unit 90 and transporting it to a predetermined direction therein. The whole control section 15 outputs the transport control data D54 to the feeder unit driving section 41.

The feeder unit driving section 41 decodes, for example, the transport control data D54 to generate a feeder unit control signal S20 and an ADU control signal S90. The feeder unit driving section 41 outputs the feeder unit control signal S20 to the feeder unit 20. The feeder unit 20 transports the sheet of paper P to the image forming portion 60 based on the feeder unit control signal S20.

In this embodiment, the feeder unit 20 is provided with a correction portion 62. The correction portion 62 corrects a transporting position of the sheet of paper P in the feeder unit 20 based on a discriminated result of the discrimination section 55 (transport correction of sheet of paper). For example, when the discrimination section 55 compares the passing position Tp of the transported sheet of paper P based on the passing position data D12 received from the data-processing section 13 with the maximum value Pmax of deviations based on the deviation characteristics data D53 and the passing position Tp falls down the maximum value Pmax of deviations, the correction portion 62 carries out the transport correction of sheet of paper. In the transport correction of sheet of paper, for example, the correction portion 62 corrects a position of sheet of paper P so that a center position of the sheet of paper is aligned with a center position of a transport of the sheet of paper by moving the registration rollers 23 holding the sheet of paper P or the image-recording paper P1 on the main scanning direction, in order to avoid any influence of the amount of deviation ε(t).

The feeder unit 20 is provided with a transport counter, not shown. The transport counter counts the sheets of paper P one by one. The feeder unit 20 then generates a detection signal Sn of number of the transported sheets of paper P. The feeder unit 20 outputs the detection signal Sn to the feeder unit driving section 41. The feeder unit driving section 41 performs analog/digital conversion on the detection signal Sn to output data Dn on the number of the transported sheets of paper P to the whole control section 15. The data Dn constitutes data indicating a frequency of occurrence in each amount of deviation ε(t).

The feeder unit driving section 41 outputs the ADU control signal S90 to the ADU inversion unit 90. The ADU inversion unit 90 inverts the sheet of paper P based on the ADU control signal S90 and transports it to the image forming portion 60. Thus, the control section of the color copy machine 100 is configured.

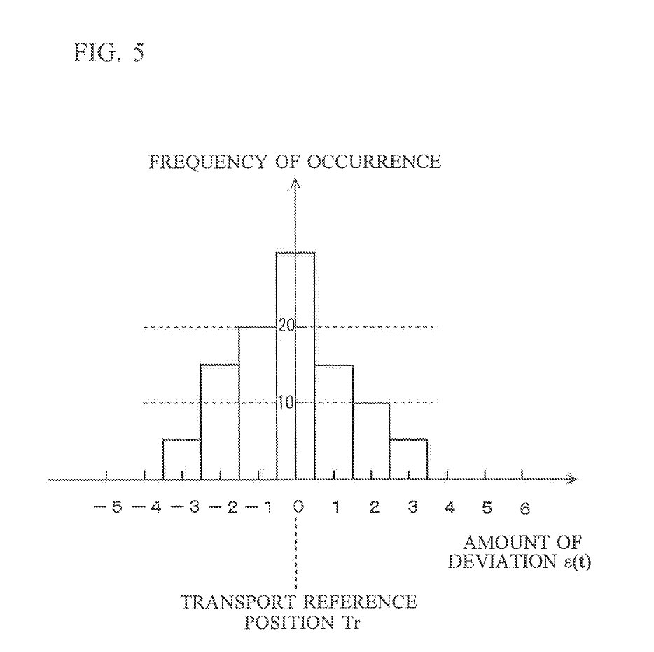

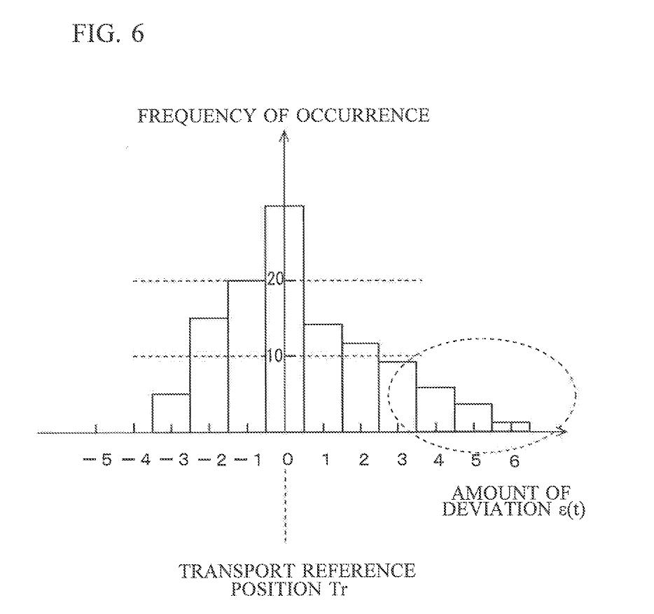

The following will describe a generation example of a histogram (normal distribution) when evaluating deviations of the sheets of paper P with reference to FIG. 5. This histogram shows a distribution of the frequency of occurrence for the amount, of deviation when N=n=100 wherein numbers of items of statistical data are N and the total number of the transported sheets of paper is “n”. In FIG. 5, a vertical axis represents the frequency of occurrence corresponding to each amount of deviation ε(t). This frequency of occurrence is obtained from the data Dn on the number of the transported sheets of paper P in the stored deviation data D52. The sum total of frequency of occurrence equals the total number “n” of the transported sheets of paper P. The total number “n” of the transported sheets of paper P constitutes numbers N of items of statistical data.

A horizontal axis represents an amount of deviation ε(t) which indicates an amount of deviation from the transport reference position on the main scanning direction. The amount of deviation ε(t) is obtained from the data indicating an amount of deviation between the passing position Tp of the transported sheet of paper P and the transport reference position Tr thereof in the stored, deviation data D52. In the amount of deviation ε(t), for example, she amount of deviation ε(t)=−5 indicates an amount of deviation of 5 pixels when a pitch by one pixel is one in the deviation detection sensor 12A.

The following table 1 indicates a relationship between the amount of deviation ε(t) and the frequency of occurrence thereof when 100 sheets of paper are transported on the deviation detection sensor 12A.

TABLE 1

| | AMOUNT OF DEVIATION ε (t) | | | | | | | | | | | |
|---|---|---|---|---|---|---|---|---|---|---|---|---|
| | −5 | −4 | −3 | −2 | −1 | 0 | 1 | 2 | 3 | 4 | 5 | 6 |
| FREQUENCY | 0 | 0 | 05 | 15 | 20 | 30 | 15 | 10 | 5 | 0 | 0 | 0 |
| OF OCCUR- | | | | | | | | | | | | |
| RENCE | | | | | | | | | | | | |

According to the table 1, when the amount of deviation ε(t) is −5 or −4, the frequency of occurrence is zero times. When the amount of deviation ε(t) is −3, the frequency of occurrence is five times. When the amount of deviation ε(t) is −2, the frequency of occurrence is fifteen times. When the amount of deviation ε(t) is −1, the frequency of occurrence is twenty times. When the amount of deviation ε(t) is 0, the frequency of occurrence is thirty times. When the amount of deviation ε(t) is 1, the frequency of occurrence is fifteen times. When the amount of deviation ε(t) is 2, the frequency of occurrence is ten times. When the amount of deviation ε(t) is 3, the frequency of occurrence is five times. When the amount of deviation ε(t) is 4, 5 or 6, the frequency of occurrence is zero times.

When representing the relationship between these amounts of deviation ε(t) and these frequencies of occurrence as the vertical axis of the frequency of occurrence, 10, 20 and 30 and the horizontal axis of amounts of deviation ε(t), −5, −4, −3, −2, −1, 0, 1, 2, 3, 4, 5 and 6, respectively, the histogram shown in FIG. 5 is obtained. Based on the distribution of these amounts of deviation ε(t) and these frequencies of occurrence in this histogram, the deviation calculating section 51 calculates the deviation average value Ave according to an equation (1) as follows:

Ave=Σ(amounts of deviation ε(t))/total number “n” of the transported sheets of paper P (1)

The deviation average value Ave is an average value of the amounts of deviation ε(t).

The deviation calculating section 51 also calculates the standard deviation Std of the deviations of transported sheets of paper according to an equation (2) as follows:

Std=(1/N)×Σ (amounts of deviation ε(t)−an average value of amounts of deviation ε(t))² (2)

The standard deviation Std is a standard deviation of the amounts of deviation ε(t).

The following will describe evaluation examples (Parts one through five) of the histograms in the discrimination section 55 with reference to FIGS. 6 through 10. The histogram shown in FIG. 6 shows a case in which numbers of items of statistical data N=100 are newly measured after the measurement of the numbers of items of statistical data N=100 from the original state of the deviation distribution (normal distribution) shown in FIG. 5 is incremented. In other words, the histogram shown in FIG. 6 shows a condition in which the transported sheets of paper are more increased than those shown in FIG. 5 and the black color board 19 is first subject to the influence of any removal of the application layer so that the distribution of the amounts of deviation ε(t) varies. The removal of the application layer from the black color board 19 occurs by increasing the number of times where the sheets of paper P transport on the same position of the black color board 19.

In this embodiment, on the histogram shown in FIG. 5, when the amount of deviation ε(t) is −3, the frequency of occurrence is five times; when the amount of deviation ε(t) is −2, the frequency of occurrence is fifteen times; when the amount of deviation ε(t) is −1, the frequency of occurrence is twenty times; when the amount of deviation ε(t) is 0, the frequency of occurrence is thirty times; when the amount of deviation ε(t) is 1, the frequency of occurrence is fifteen times; when the amount of deviation ε(t) is 2, the frequency of occurrence is ten times; and when, the amount, of deviation ε(t) is 3, the frequency of occurrence is five times. In the meantime, on the histogram shown in FIG. 6, when the amount of deviation ε(t) is −3, the frequency of occurrence is five times; when the amount of deviation ε(t) is −2, the frequency of occurrence is fifteen times; when the amount, of deviation ε(t) is −1, the frequency of occurrence is twenty times; when the amount, of deviation ε(t) is 0, the frequency of occurrence is thirty times; when the amount of deviation ε(t) is 1, the frequency of occurrence is fourteen times; when the amount of deviation ε(t) is 2, the frequency of occurrence is twelve times; when the amount of deviation ε(t) is 3, the frequency of occurrence is nine times; when the amount of deviation ε(t) is 4, the frequency of occurrence is six times; when the amount of deviation ε(t) is 5, the frequency of occurrence is three times; and when the amount of deviation ε(t) is 6, the frequency of occurrence is one time.

On the histogram shown in FIG. 6, it has been measured as shown, in a dotted oval of FIG. 6 that when the amount of deviation ε(t) is 4, the frequency of occurrence is six times; when the amount of deviation ε(t) is 5, the frequency of occurrence is three times; and when the amount of deviation ε(t) is 6, the frequency of occurrence is one time, in comparison to the histogram shown in FIG. 5. Such a measurement indicates that any removal of the application layer from the black color board 19 starts occurring.

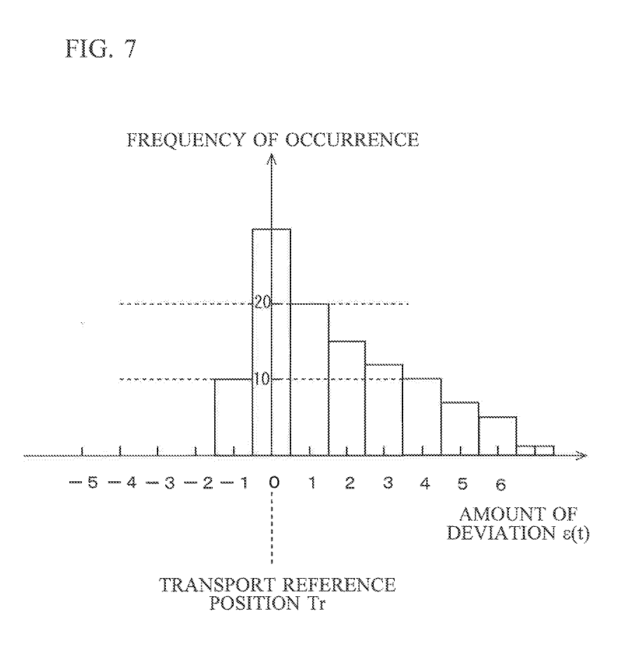

The histogram shown in FIG. 7 shows a case in which numbers of items oil statistical data N=100 are newly measured after the measurement of the numbers of items of statistical data N=100 shown in FIG. 6 are incremented. In other words, the histogram shown in FIG. 7 shows a condition in which the transported sheets of paper are more increased than those shown in FIG. 6 and a black application layer of the black color board 19 is further removed and a based metal plate is exposed so that the black color board 19 is made specular, thereby causing any errors in the measurement frequently.

In this embodiment, on the histogram shown in FIG. 7, when the amount of deviation ε(t) is −1, the frequency of occurrence is ten times; when the amount of deviation ε(t) is 0, the frequency of occurrence is thirty times; when the amount of deviation ε(t) is 1, the frequency of occurrence is twenty times; when the amount of deviation ε(t) is 2, the frequency of occurrence is fifteen times; when the amount of deviation ε(t) is 3, the frequency of occurrence is twelve times; when the amount of deviation ε(t) is 4, the frequency of occurrence is ten times; when the amount of deviation ε(t) is 5, the frequency of occurrence is seven times; when the amount of deviation ε(t) is 6, the frequency of occurrence is five time; and when the amount of deviation ε(t) is 7, the frequency of occurrence is one time.

The histogram shown in FIG. 7 indicates a situation where any errors occur at a minus side in relation to the transport reference position Tr. When the black application layer of the black, color board 19 is removed in relation to the transport reference position Tr, the deviation detection sensor 12A detects a position by one pixel before the correct position in error as a side edge of the sheet of paper P.

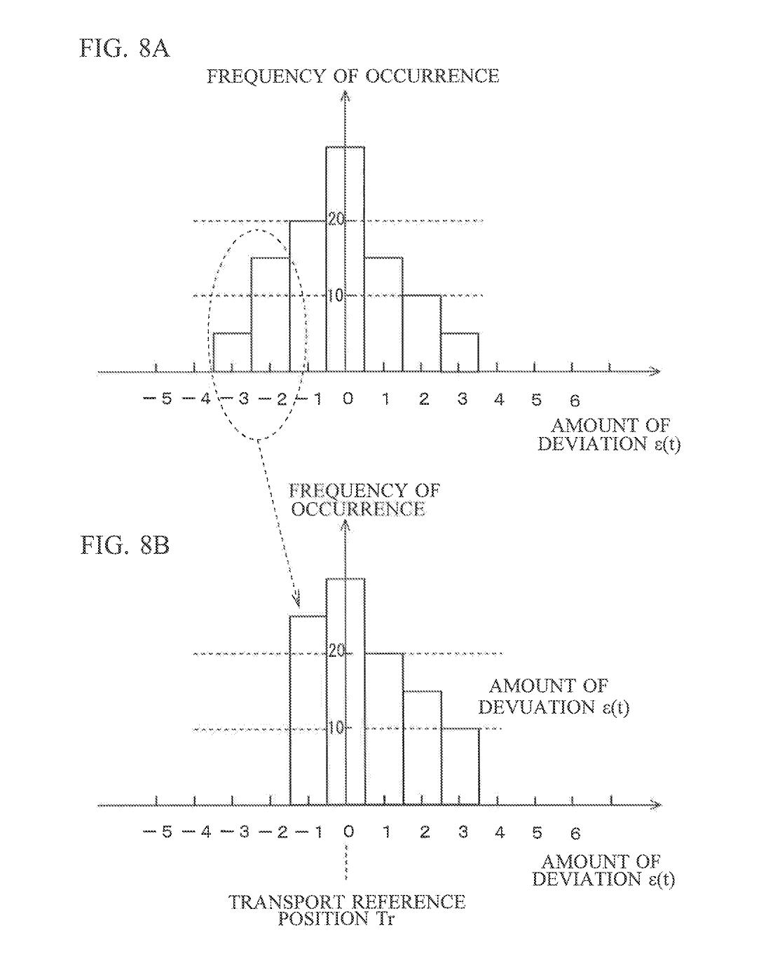

The histograms shown in FIGS. 8A and 8B show a case in which no black application layer of the black color board 19 is removed and the side edges of the sheets of paper P are more detected at one side, in this embodiment, plus side than the other side because of any reason in the transporting section. The histogram shown in FIG. 5B shows a case in which numbers of items of statistical data N=100 are newly measured after the measurement of the numbers of items of statistical data N=100 from the original state of the deviation distribution (normal distribution) shown in FIG. 8A is incremented. In other words, the histogram shown in FIG. 8B shows a condition in which the transported sheets of paper are more increased than those shown in FIG. 8A so that the distribution of the amounts of deviation ε(t) of the sheets of paper P varies because of any reason in the transporting section.

In this embodiment, on the histogram shown in FIG. 8A, when the amount of deviation ε(t) is −3, the frequency of occurrence is five times; when the amount of deviation ε(t) is −2, the frequency of occurrence is fifteen times; when the amount or deviation ε(t) is −1, the frequency of occurrence is twenty times; when the amount of deviation ε(t) is 0, the frequency of occurrence is thirty times; when the amount of deviation ε(t) is 1, the frequency of occurrence is fifteen times; when the amount of deviation ε(t) is 2, the frequency of occurrence is ten times; when the amount of deviation ε(t) is 3, the frequency of occurrence is five times. In the meantime, on the histogram shown in FIG. 8B, when the amount of deviation ε(t) is −3, the frequency of occurrence is zero times; when the amount of deviation ε(t) is −2, the frequency of occurrence is zero times; when the amount of deviation ε(t) is −1, the frequency of occurrence is twenty five times; when the amount of deviation ε(t) is 0, the frequency of occurrence is thirty times; when the amount of deviation ε(t) is 1, the frequency of occurrence is twenty times; when the amount of deviation ε(t) is 2, the frequency of occurrence is fifteen times; and when the amount of deviation ε(t) is 3, the frequency of occurrence is ten times.

This measurement indicates that the amounts of deviation ε(t) of the sheets of paper P are more detected at the plus side in relation to the transport, reference position Tr than the minus side because of any reason in the transporting section. Such a condition indicates that there is malfunction in the setting of the tray 291 or the like in the feeder unit 20. However, even in this case, when tray 291 or the like is set near a predetermined value and the passing position Tr of the transported sheet of paper P does not exceed the predetermined value in the deviation on the main scanning direction in relation to the transporting direction of the sheets of paper P, the writing position correction function functions so that the image position is suitably corrected on each of the sheets of paper P and the image position is not gotten out of correct position.

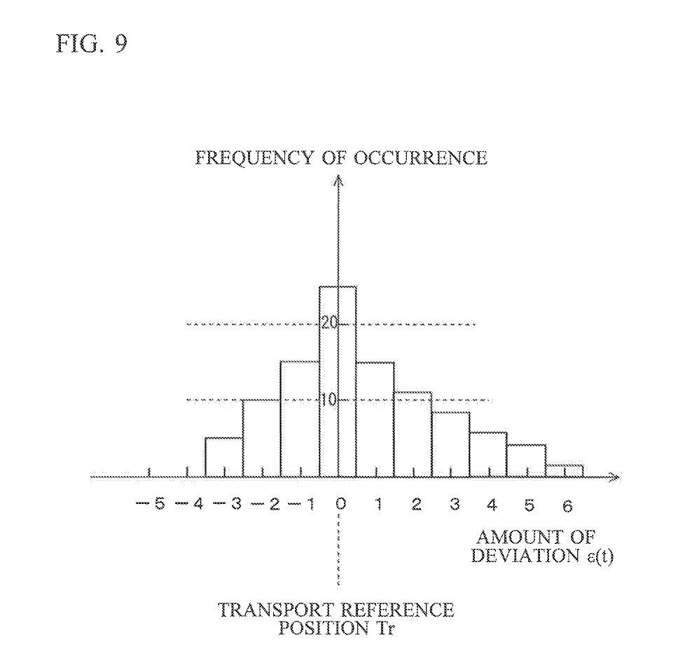

The histograms shown in FIG. 9 shows a case in which no black application layer of the black color board 19 is removed, and the sheets of paper P are reasonably deviated to a plus side of the amount of deviation ε(t) more than a minus side thereof because of any reason in the transporting section. The histogram shown in FIG. 9 shows a case in which numbers of items of statistical data N=100 are newly measured after the measurement of the numbers of items of statistical data N=100 from, the original state of the deviation distribution (normal distribution) shown in FIG. 8A is incremented. In other words, the histogram shown, in FIG. 9 shows a condition in which, the transported sheets of paper are more increased than those shown in FIG. 8A so that the distribution of the amounts of deviation ε(t) of the sheets of paper P varies because of any reason in the transporting section.

In this embodiment, on the histogram shown in FIG. 8A, when the amount of deviation ε(t) is −3, the frequency of occurrence is five times; when the amount of deviation ε(t) is −2, the frequency of occurrence is fifteen times; when the amount of deviation ε(t) is −1, the frequency of occurrence is twenty times; when the amount of deviation ε(t) is 0, the frequency of occurrence is thirty times; when the amount of deviation ε(t) is 1, the frequency of occurrence is fifteen times; when the amount of deviation ε(t) is 2, the frequency of occurrence is ten times; when the amount of deviation ε(t) is 3, the frequency of occurrence is five times. In the meantime, on the histogram shown in FIG. 9, when the amount of deviation ε(t) is −3, the frequency of occurrence is five times; when the amount of deviation ε(t) is −2, the frequency of occurrence is ten times; when the amount of deviation ε(t) is −1. the frequency of occurrence is fifteen times; when the amount of deviation sits is 0, the frequency of occurrence is twenty five times; when the amount of deviation ε(t) is 1, the frequency of occurrence is fifteen times; when the amount of deviation ε(t) is 2, the frequency of occurrence is twelve times; when the amount of deviation ε(t) is 3, the frequency of occurrence is eight times; when the amount of deviation ε(t) is 4; the frequency of occurrence is six times; when the amount of deviation ε(t) is 5, the frequency of occurrence is four times; and when the amount of deviation ε(t) is 6, the frequency of occurrence is one time.

This measurement indicates that the amounts of deviation ε(t) of the sheets of paper P are more detected at the plus side in relation to the transport reference position Tr than the minus side because of any reason in the transporting section. Such a condition indicates that there is malfunction in the setting position of the tray 291 or the like in the feeder unit 20. In this case, even when tray 291 or the like is set near a predetermined value, any necessary writing position correction function fails if the passing position Tp of the transported, sheet of paper P exceeds the predetermined value in the large deviation on the main scanning direction in relation to the transporting direction of the sheets of paper P, so that the image position is gotten out of correct position of each of the sheets of paper P.

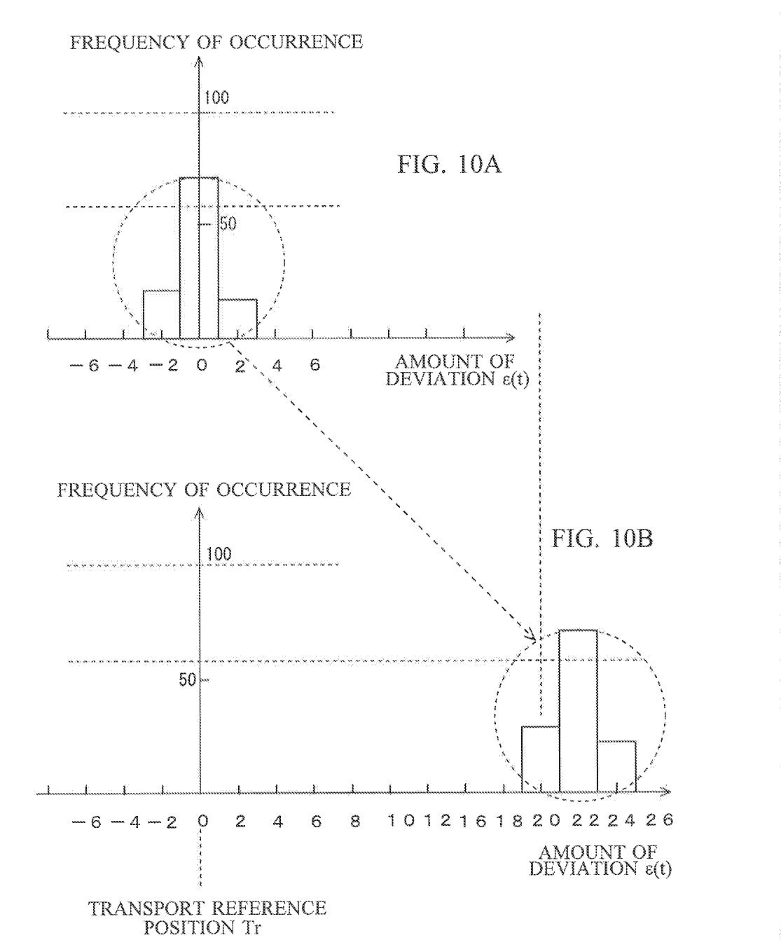

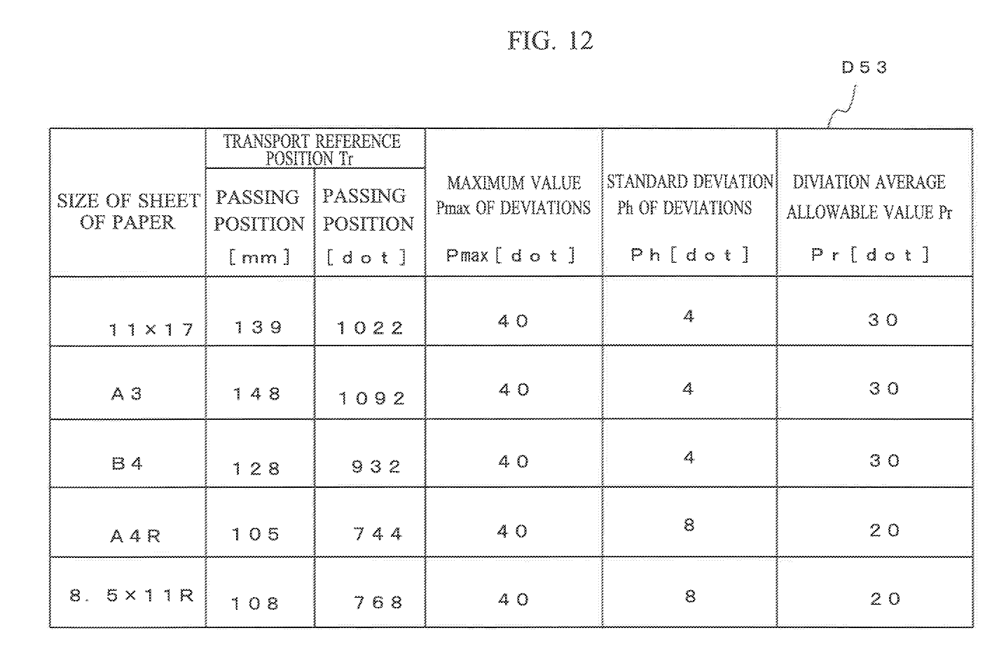

The histograms shown in FIGS. 10A and 10B show a case in which, no black application layer of the black color board 19 is removed and the amount of deviation ε(t) is reasonably shifted to a plus side in relation to the amount of deviation ε(t) on a correct detection time thereof because of any reason in the transporting section. This case is a case where it is determined from the deviation average value Ave that there is malfunction in the setting of the tray 291 or the like. FIG. 10A shows a histogram of the deviation characteristics data D53 shown in FIG. 12 (the deviation average allowable value Pr is 20). When there is malfunction in the setting of the tray 291 or the like, it is a characteristic that the deviation average value Ave is reasonably shifted from its target in spite of good degrees of the deviation of the transported sheets of paper P.

The histogram shown in FIG. 10B shows a case in which numbers of items of statistical data N=100 are newly measured after the measurement of the numbers of items of statistical data N=100 from the original state of the deviation distribution (normal distribution) shown in FIG. 10A is incremented. In other words, the histogram shown in FIG. 10B shows a condition in which the setting of the tray 291 or the like reasonably varies in relation to that shown in FIG. 10A so that the distribution of the amounts of deviation ε(t) of the sheets of paper P reasonably varies.

In this embodiment, on the histogram shown in FIG. 10A, when the amount of deviation ε(t) is −2, the frequency of occurrence is twenty times; when the amount of deviation ε(t) is 0, the frequency of occurrence is sixty four times; and when the amount of deviation ε(t) is 2, the frequency of occurrence is sixteen times. In the meantime, on the histogram, shown in FIG. 10B, when the amount of deviation ε(t) is 20, the frequency of occurrence is twenty times; when the amount of deviation ε(t) is 22, the frequency of occurrence is sixty four times; and when the amount of deviation ε(t) is 24, the frequency of occurrence is sixteen times.

This measurement indicates that the amounts of deviation ε(t) of the sheets of paper P are reasonably shifted to the plus side in relation to the transport reference position Tr because of any reason in the transporting section and are detected over the deviation average allowable value Pr of 20. Such a condition indicates that there is malfunction in the setting of the tray 291 or the like in the feeder unit 20 over the predetermined value. In this case, since there is malfunction in the setting of the trey 291 or the like over the predetermined value, the manipulation section 48 warns a user that there is malfunction in the setting of the tray 291 or the like.

In this embodiment, the discrimination section 55 compares the deviation average value Ave with the deviation average allowable value Pr to discriminate chat there is malfunction in the transporting section when the deviation average value Ave exceeds the deviation average allowable value Pr of 20. Thus, the manipulation section 48 displays a warning, “Please check setting of feeding tray”.

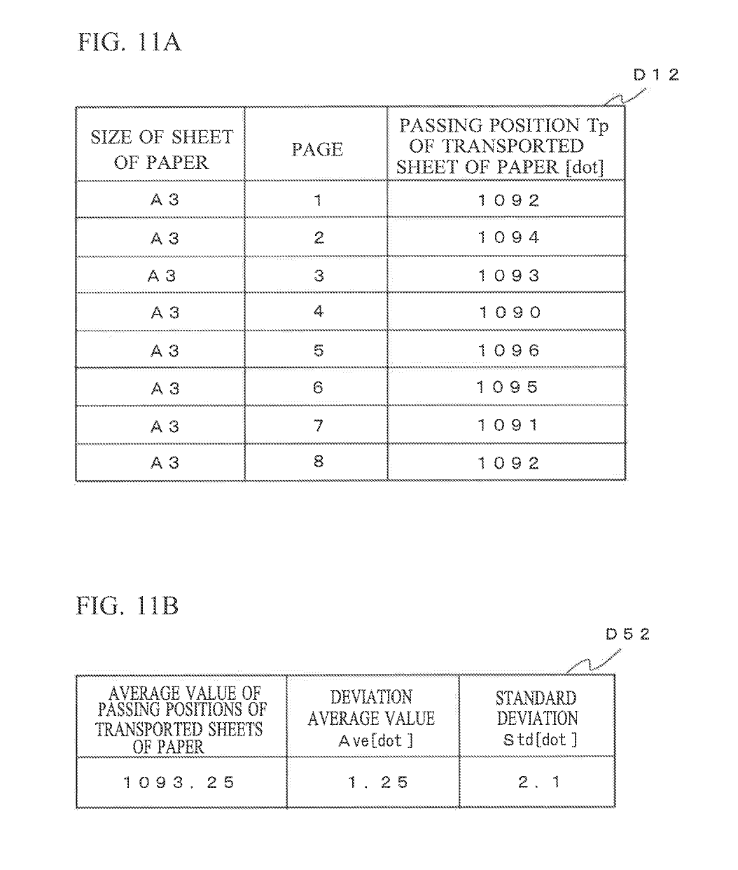

The following will describe tables for showing storage examples of the passing position data D12 of transported sheets of paper stored in the measured-data-storing section 52 and the stored deviation data D52 as the evaluation information for evaluating a condition of the sheet of paper P in the transporting section or the detection section thereof with reference to FIGS. 11A and 11B. In the table for showing the storage example of the passing position data D12 as shown in FIG. 11A, description columns of a size of sheet of paper, page and passing position Tp of transported sheet of paper are provided in a memory region of the measured-data-storing section 52. The measured-data-storing section 52 stores the size of each of the transported sheets of paper P and the passing position Tp of the transported sheet of paper P for every page. The passing position Tp indicates passing position [dot] of the transported sheet of paper P based on the sensor.

In this embodiment, the storage example of the passing position data D12 when eight sheets of paper P each having a size of A3 are transported on the deviation detection sensor 12A is illustrated. The deviation detection sensor 12A has a resolution of 200 [dpi]. The passing position Tp of the first, page is 1092 [dot]; the passing position Tp of the second page is 1094 [dot]; the passing position Tp of the third page is 1093 [dot]; the passing position Tp of the fourth page is 1090 [dot]; the passing position Tp of the fifth page is 1096 [dot]; the passing position Tp of the sixth page is 1095 [dot]; the passing position Tp of the seventh page is 1091 [dot]; and the passing position Tp of the eighth page is 1092 [dot]. It is to be noted that when the passing position Tp is indicates as the passing position based on the transport center, a distance to which dot numbers of the deviation detection sensor 12A are converted is used, for example, 1 [dot]=0.127 mm, if the deviation detection sensor 12A has a resolution of 200 [dpi].

In the table for showing the storage example of the stored deviation data D52 as the evaluation information, as shown in FIG. 11B, description columns of the average value of passing positions of the transported sheets of paper, the deviation average value Ave and the standard deviation Std are provided in another memory region of the measured-data-storing section 52. The deviation calculating section 51 performs a statistical processing on the transport deviations and calculates the average value of passing positions of the transported sheets of paper, the deviation average value Ave and the standard deviation Std as representative values. The measured-data-storing section 52 stores these representative values. In this embodiment, in the description columns, the average value of passing positions of the transported sheets of paper of 1093.25 is described, the deviation average value Ave of 1.25 is described and the standard deviation Std of 2.1 is described.

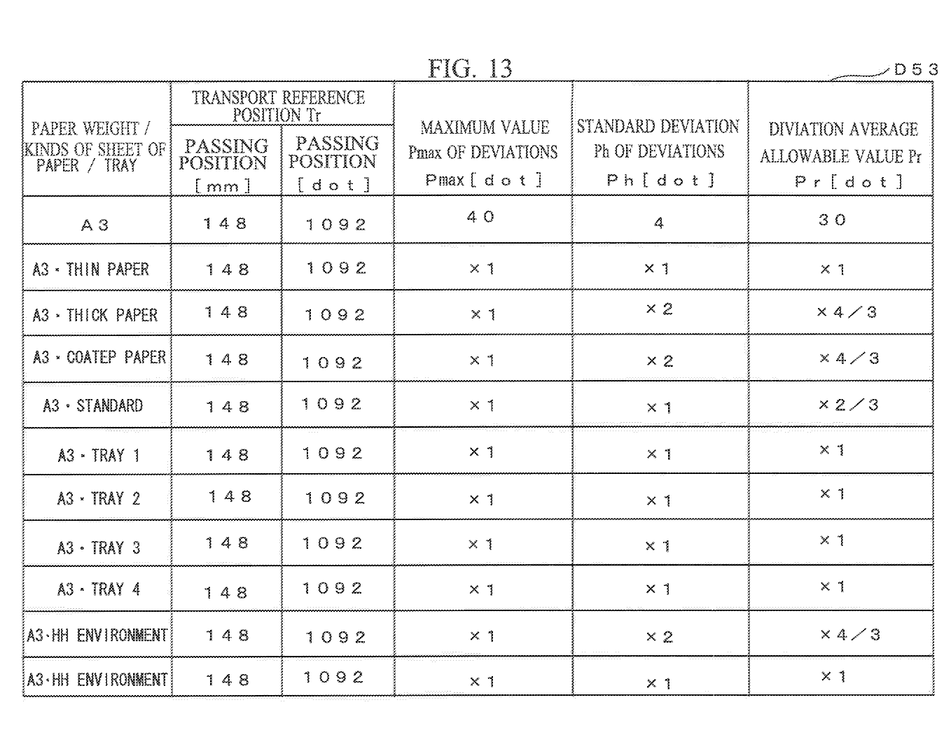

The following describe a storage example (part one and part two) of deviation characteristics data B53 stored in the characteristics-data-storing section 53 with reference to FIGS. 12 and 13. The deviation characteristics data D53 are shown as an exemplification and is not limited thereto. In the table for showing the storage example (part one) of the deviation characteristics data D53 as shown in FIG. 12, description columns of a size of sheet of paper, a passing position [mm] of sheet of paper based on transport center, a passing position [dot] of sheet of paper based on a sensor, a maximum value Pmax [dot] of deviations, a standard, deviation Ph [dot] of deviations and deviation average allowable value Pr [dot] are provided in a memory region of the characteristics-data-storing section 53. The passing position [mm] of sheet of paper based on transport center and the passing position [dot] of sheet of paper based on the sensor are values for describing the transport reference position Tr.

Here, the passing position [mm] of sheet of paper based on transport center is a designed passing position when the sheet of paper P is transported having no deviation and a distance between the reference position based on transport center and an edge of the sheet of paper. The passing position [dot] of sheet of paper based on the sensor is a designed passing position when the sheet of paper P is transported having no deviation and a serial-dot number (sensor dot number) when counting the dots in order from a first dot corresponding to a first bit of the sensor to an edge of the sheet of paper. The passing position [dot] of sheet of paper based on the sensor has the same technical meaning as the passing position [mm] of sheet of paper based on transport center so that they both are described in the image forming apparatus for managing the passing position [mm] of sheet of paper based on transport center using the sensor dot number.

The maximum value Pmax [dot] of deviations is referred to as “a maximum value of the amount of deviation ε(t) when correcting the deviation of the sheet of paper”. For the maximum value of the amount of deviation ε(t), a value obtained by subtract the passing position [dot] of sheet of paper based on the sensor from a really detected passing position Tp of the transported sheet of paper P is used. The standard deviation Ph [dot] of deviations is referred to as “an allowable value in the deviation of the transported sheets of paper P”. The deviation average allowable value Pr [dot] is referred to as “an allowable value of the average value of the really detected passing position Tp of the transported sheet of paper P”. In this embodiment, when the deviation average value Ave stays within the deviation average allowable value Pr [dot], the machine normally operates.

In this embodiment, the deviation characteristics data D53 includes characteristics of typical five pieces of sheets of paper P in which sizes of sheet of paper are 11×17, A3, B4, A4R and 8.5×11R. The passing position of sheet of paper based on transport center constituting the deviation-characterstics-data of the sheet of paper P having a size of 11×17 is 139 [mm].

Its passing position of sheet of paper based on the sensor is 1022 [dot]. Its maximum value Pmax of deviations is 40 [dot]. Its standard deviation Ph of deviations is 4 [dot]. Its deviation average allowable value Pr is 30 [dot].

The passing position of sheet of paper based, on transport center of the sheet of paper P having a size of A3 is 148 [mm]. Its passing position of sheet of paper based on the sensor is 1092 [dot]. Its maximum value Pmax of deviations is 40 [dot]. Its standard deviation Ph of deviations is 4 [dot]. Its deviation average allowable value Pr is 30 [dot].

The passing position of sheet of paper based on transport center of the sheet of paper P having a size of B4 is 128 [mm]. Its passing position of sheet of paper based on the sensor is 932 [dot]. Its maximum value Pmax of deviations is 40 [dot]. Its standard deviation Ph of deviations is 4 [dot]. Its deviation average allowable value Pr is 30 [dot].

The passing position of sheet of paper based on transport center of the sheet of paper P having a size of A4R is 105 [mm]. Its passing position of sheet of paper based on the sensor is 744 [dot]. Its maximum value Pmax of deviations is 40 [dot]. Its standard deviation Ph of deviations is 8 [dot]. Its deviation average allowable value Pr is 20 [dot].

The passing position of sheet of paper based on transport center of the sheet of paper P having a size of 8.5×11R is 108 [mm]. Its passing position of sheet of paper based on the sensor is 768 [dot]. Its maximum value Pmax of deviations is 40 [dot]. Its standard deviation Ph of deviations is 8 [dot]. Its deviation average allowable value Pr is 20 [dot]. These characteristics are reference values for correctly specifying that there is malfunction in setting of the transporting section of the sheet of paper P or error detection in the detection section of sheet of paper P.

The storage example (part two) of the deviation characteristics data D53 as shown in FIG. 13 relates to data, of the sheets of paper P having a size of A3 extracted from, the description columns of the deviation characteristics data D53, as shown in FIG. 12, stored in the memory region of the characteristics-data-storing section 53. The storage example shows the storage example of the deviation characteristics data D53 of respective sheets of paper having a size of A3.

In the table for showing the storage example of respective sheets of paper having a size of A3 in the deviation characteristics data D53 as shown in FIG. 13, description columns of paper weight/kinds of paper/tray, a passing position [mm] of sheet of paper based on transport, center, a passing position [dot] of sheet of paper based on a sensor, a maximum value Pmax [dot] of deviations, a standard deviation Ph [dot] of deviations and deviation average allowable value Pr [dot] are provided in a memory region of the characteristics-data-storing section 53.

In this embodiment, in spite of the deviation characteristics data D53 of the sheet of paper having a size of A3 as shown in FIG. 12, another storage method of the deviation characteristics data D53 is shown with paper weight, kinds of sheet of paper and tray position being as parameters. In this storage example of the deviation characteristics data D53, the maximum value Pmax of deviations, the standard deviation Ph of deviations and deviation average allowable value Pr are all represented as an amount of correction in relation to their reference value of the sheet of paper having a size of A3.

For example, in the description columns of the sheet, of paper P having a size of A3, the passing position of sheet of paper based on transport, center is 148 [mm]. Its passing position of sheet of paper based on the sensor is 1092 [dot]. Its maximum value Pmax of deviations is 40 [dot]. Its standard deviation Ph of deviations is 4 [dot]. Its deviation average allowable value Pr is 30 [dot].

In the respective description columns of the sheet of paper P having a size of A3 and thin paper, the sheets of paper P having a size of A3 and trays 1 through 4, and the sheet of paper P having a size of A3 and LL environment, the passing position of sheet of paper based on transport center is 148 [mm]. Their passing positions of sheets of paper based on the sensor are respectively 1092 [dot]. Their maximum values Pmax of deviations are respectively shown as x1 [dot]. Their standard deviations Ph of: deviations are respectively shown as x1 [dot]. Their deviation average allowable values Pr are respectively shown as x1 [dot].

In the respective description columns of the sheet of paper P having a size of A3 and thick paper, the sheet of paper P having a size of A3 and coated paper and the sheet of paper P having a size of A3 and HH environment, the passing position of sheet of paper based on transport center is 148 [mm]. Their passing positions of sheets of paper based on the sensor are respectively 1092 [dot]. Their maximum values Pmax of deviations are respectively shown as x1 [dot]. Their standard deviations Ph of deviations are respectively shown, as x2 [dot]. Their deviation average allowable values Pr are respectively shown as x4/3 [dot].

In the description columns of the sheet of paper P having a size of A3 and plain paper, the passing position of sheet of paper based on transport center is 148 [mm]. Its passing positions of sheet of paper based on the sensor are 1092 [dot]. Its maximum value Pmax of deviation is shown as x1 [dot]. Its standard deviation Ph of deviation is shown as x1 [dot]. Its deviation average allowable value Pr is shown, as x2/3 [dot].

It is to be noted that in the drawing, the representation, “x1” means that it is the same as the reference value and the representation, “x2” means that it is twice as large as the reference value. For example, in a case of the sheet of paper P having a size of A3 and coated paper, the standard, deviation Ph of deviation becomes 4×2×2=16 [dot] when the color copy machine 100 is used under an environment of high temperature (hereinafter, referred to as “HH environment”). The LL environment is a case where the color copy machine 100 is used under an environment of low humidity.

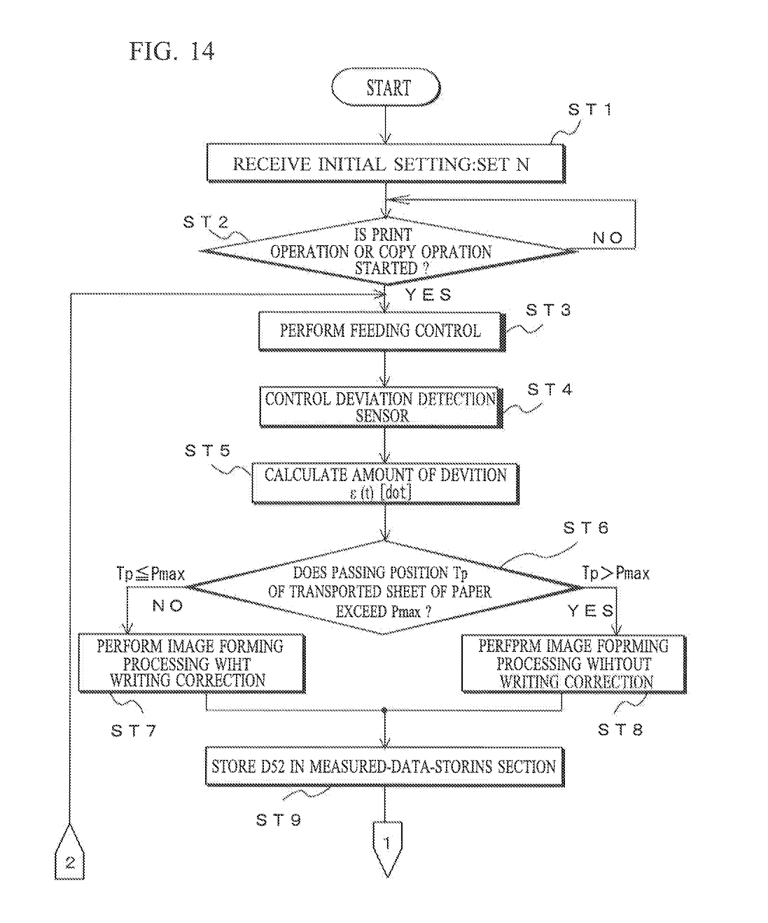

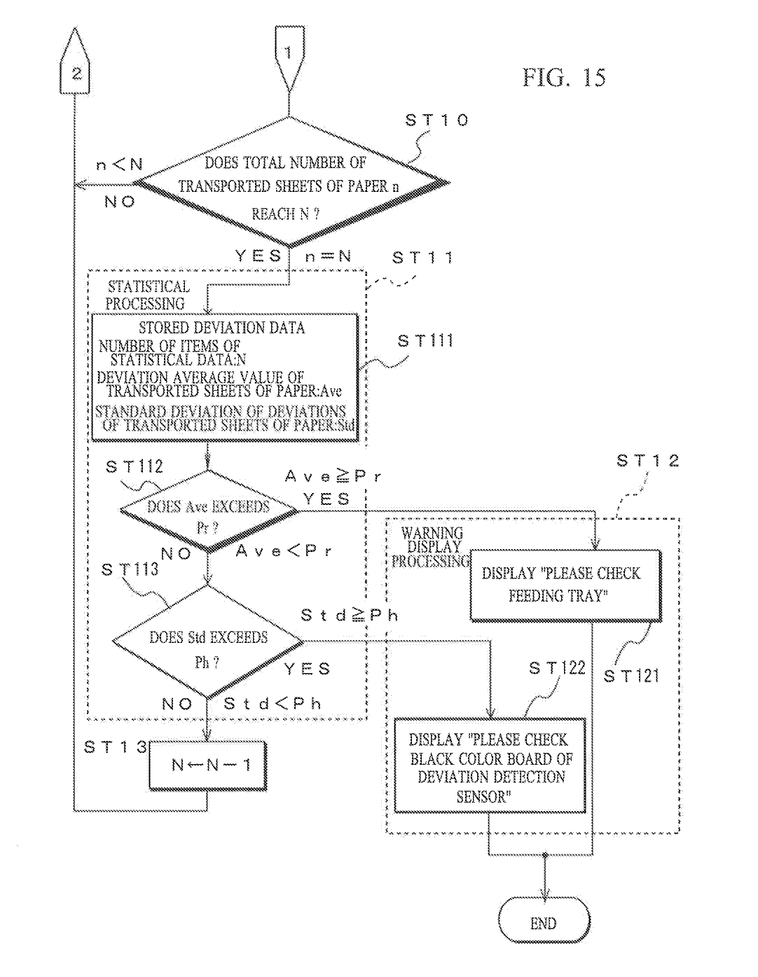

The following will describe an example of an operation of the color copy machine 100 when performing the statistical processing with reference to FIGS. 14 and 15. In this embodiment, it is assumed that in the printing operation or the copy operation, a simplex printing mode is set and a plurality of sheets of paper is printed. Since the simplex printing mode is set, the deviation detection sensor 12A operates and the ADU inversion unit 90 and the deviation detection sensor 123 do not operate.

In this embodiment, when the passing position Tp of the transported sheet of paper P is not more than the maximum value Pmax of deviations, the writing position of image is corrected. In this moment, the maximum value Pmax of deviations is set for every paper weight, kind of sheet of paper or tray. The maximum value Pmax of deviations is read our of the characteristics-data-storing section 53 and used.

On control conditions of them, as shown in FIG. 14, at a step ST1, the whole control section 15 receives an initial setting. In the initial setting, the numbers of items of statistical data N is set so that N is incremented when the total number of the transported sheets of paper “n” reaches N. For example, a user manipulates the manipulation section 48 to set the numbers of items of statistical data N in the discrimination section 55 of the whole control section 15. The numbers of items of statistical data N are set for discriminating between a case in which there is malfunction in the setting of feeding tray 291 or the like in the feeder unit 20 and a case in which there is malfunction in the black color board 19 of the deviation detection sensor 12A or the like.

Next, at a step ST2, the whole control section 15 waits for starting the print operation or the copy operation. When starting it (YES), the whole control section 15 performs feeding control of the sheets of paper P at a step ST3. In this moment, in the whole control section 15, the driving control section 54 outputs the transport control data D54 to the feeder unit driving section 41 which connects the driving control section 54 through the I/O interface 56.

The feeder unit driving section 41 controls the feeder unit 20 based on the transport control data D54. The transport control data D54 is used for controlling the feeder unit 20 to feed the sheets of paper P one by one to image forming portion 60. The feeder unit driving section 41 decodes the transport control data D54 to generate the feeder unit control signal S20.

The feeder unit driving section 41 then outputs the feeder unit control signal S20 to the feeder unit 20. The feeder unit 20 transports the sheets of paper P one by one to the image forming portion 60 based on the feeder unit control signal S20.

At a step ST4, the whole control section 15 then controls the deviation detection sensor 12A so as to detect a deviation of the sheet of paper P for every page (deviation detection control). In this moment, the driving control section 54 outputs the sensor driving data D11 (instructions) to the sensor driving section 11 and controls the sensor driving section 11. The sensor driving section 11 drives the deviation detection sensor 12A based on the sensor driving data D11 during the feeding of the sheets of paper.

The deviation detection sensor 12A detects the passing position of the side edge of each of the transported sheets of paper P fed from the feeder unit 20 and generates a passing position detection signal S12 for every transported sheet of paper P to output it to the data-processing section 13. The data-processing section 13 receives the passing position detection signal S12 and performs analog/digital conversion and the like on the passing position detection signal S12 to generate the passing position data D12 (passing position information of the transported sheets of paper). The data-processing section 13 also outputs the passing position data D12 to the whole control section 15. The passing position data D12 relates to any information indicating to a passing position Tp of the transported sheet of paper P (passing position information [dot] of the transported sheets of paper). The measured-data-storing section 52 of the whole control section 15 stores the passing position data D12 for every page (see FIG. 11A). Thus, items of the passing position data D12 indicating the passing position of the side edge of each of the sheets of paper P may be obtained.

At a step ST5, the whole control section 15 calculates the amount of deviation ε(t) [dot]. In this moment, in the whole control section 15, the deviation calculating section 51 reads the deviation characteristics data D53 indicating the transport reference position Tr of the transported sheet of paper P out of the characteristics-data-storing section 53. The deviation calculating section 51 then calculates the amount of deviation ε(t) [dot] by calculating the difference between the passing position Tp of the transported sheet of paper P based on the passing position data D12 and the transport, reference position. Tr of the transported sheet of paper P. The calculated amount of deviation ε(t) between the passing position Tp of the transported sheet of paper P and the transport reference position Tr of the transported sheet of paper P corresponds to the data indicating a frequency of occurrence, so that they constitutes the stored deviation data D52.

At a step ST6, the whole control section 15 compares the passing position Tp of the transported sheet of paper P with the maximum value Pmax of deviations based on the deviation characteristics data D53 to determine whether or not a correction of a start position for writing the image is required. In this moment, the discrimination section 55 compares the passing position Tp of the transported sheet of paper P based on the passing position data D12 received from the data-processing section 13 with the maximum value Pmax of deviations based on the deviation characteristics data D53.

If the passing position Tp of the transported, sheet of paper P is not more than the maximum value Pmax of deviations, then the whole control section 15 controls the driving control section 54 to correct the position for writing the image at a step ST7. For example, the driving control section 54 outputs image data Dy to the writing control section 16Y for yellow. In this moment, the correction portion 61 corrects the start position for writing the yellow image based on the discriminated result of the discrimination section 55. The writing control section 16Y forms the yellow image based on the corrected image data Dy.

The driving control section 54 also outputs items of image data Dm, Dc and Dk to other writing control sections 16M, 16C and 16K for magenta, cyan and black. In this moment, the correction portion 61 corrects the start positions for writing the magenta, cyan and black images. The writing control sections 16M, 16C and 16K form the magenta, cyan and black images based on items of the corrected image data Dm, Dc and Dk. Thus, the image forming processing can be carried out with correcting the start positions for writing the images.

At the step ST6, if the passing position Tp of the transported, sheet of paper P is more than the maximum value Pmax of deviations, then the whole control section 15 goes to a step ST8 where the images are formed based on items of the image data Dy, Dm, Dc and Dk without any correction of the start positions for writing the images.

At a step ST9, the whole control section 15 controls the measured-data-storing section 52 to store the stored deviation data D52 thereon. In this moment, the discrimination section 55 corresponds the amount of deviation ε(t) to the data indicating a frequency of occurrence, so that they constitute the stored deviation data D52. The measured-data-storing section 52 stores the stored deviation data D52 in which the amount of deviation ε(t) corresponds to the frequency of occurrence (see the table 1).

At a step ST10 shown in FIG. 15, the whole control section 15 determines whether or not the total number of the transported sheets of paper “n” reaches the numbers of items of statistical data N. In this moment, if the total number of the transported sheets of paper “n” does not reach the numbers of items of statistical data N, then the whole control section 15 goes back to the step ST3 where the feeding operation of sheets of paper P is continued. For example, items of the stored deviation data D52 are stored up to a moment when the total number of the transported sheets of paper “n” reaches 100 sheets of paper (the items of statistical data N=100).

If the total number of the transported sheets of paper “n” reaches the numbers of items of statistical data N, then the whole control section 15 goes to a step ST11 where the discrimination section 55 performs a statistical processing. In this statistical processing, the deviation calculating section 51 or the measured-data-storing section 52 outputs the stored deviation data D52 for evaluating the condition of the transporting section or the detection section to the discrimination section 55. The characteristics-data-storing section 53 outputs the deviation characteristics data D53 to be compared with the stored deviation data D52 to the discrimination section 55.

According to this statistical processing, at a step ST111 which is a subroutine of the step ST11, the whole control section 15 performs the statistical processing on the stored deviation data D52 of the transported sheets of paper P to generate evaluation information for evaluating the condition of the transporting section, or the detection section. In this embodiment, the deviation calculating section 51 calculates the deviation average value Ave and the standard deviation Std of the deviations of transported sheets of paper as the evaluation information.

The deviation calculating section 51 calculates the deviation average value Ave according to the above-mentioned equation (1) and the standard deviation Std of the deviations according to the above-mentioned equation (2). The deviation average value Ave is used for specifying that there is malfunction on the sheet of paper in the transporting section. The standard deviation Std of the deviations is used for specifying that there is malfunction in the detection section.

At a step ST112, the discrimination section 55 compares the deviation average value Ave with the deviation average allowable value Pr to specify whether or not there is malfunction on the sheet of paper in the transporting section. The deviation average allowable value Pr constitutes the deviation characteristics data D53 and is read out of the characteristics-data-storing section 53. If the deviation average value Ave exceeds the deviation average allowable value Pr (see FIG. 10B), i.e., Ave>=Pr, then the whole control section 15 goes to a step ST12 where the discrimination section 55 carries out any warning display processing.

On this warning display processing, at a step ST121 which is a subroutine of the step ST12, the discrimination section 55 controls the manipulation section 48 to display a warning, “Please check setting of feeding tray”. The manipulation section 48 displays “Please check setting of feeding tray” based on display data D18 output from the whole control section 15. The display data D18 relates to character information for displaying “Please check setting of feeding tray” or icon image information displaying feeding tray image.

If the deviation average value Ave does not exceed the deviation average allowable value Pr, i.e., Ave<Pr, at the step ST112, then the whole control section 15 goes to a step ST113. At the step ST113, the discrimination section 55 compares the standard deviation Std of the deviations with the reference standard deviation Ph of the deviations to specify whether or not there is malfunction in the detection section. The reference standard deviation Ph of the deviations constitutes the deviation characteristics data D53 and is read out; of the characteristics-data-storing section 53.

In this embodiment, if the standard deviation Std of the deviations exceeds the reference standard deviation Ph of the deviations (see FIGS. 6 and 7), i.e., Std>=Ph, then the whole control section 15 goes to a step ST122 where the whole control section 15 carries out any warning display processing.

At the step ST122, the whole control section 15 controls the manipulation section 48 to display a warning, “Please check black color board of deviation detection sensor”. The manipulation section 48 displays a warning, “Please check black color board of deviation detection sensor” based on display data D18 output from the whole control section 15. The display data D18 relates to character information for displaying “Please check black color board of deviation detection sensor” or icon image information displaying the deviation detection sensor 12A and its black color board 19.

If the standard deviation Std of the deviations does not exceed the reference standard deviation Ph of the deviations, i.e., Std<Ph, then the whole control section 15 goes to a step ST13. In this embodiment, when the total number of the transported sheets of paper “n” to be processed in the statistical processing reaches the numbers of items of statistical data N, the statistical processing is always carried out during printing JOB with the amount of deviation ε(t) being detected. Accordingly, at the step ST13, the whole control section 15 increments the numbers of items of statistical data. N (N←N−1) to set a new N in which new total number of the transported sheets of paper “n” reaches the new N. The whole control section 15 then goes back to the step ST3 where the above-mentioned feeding control is continued.

Thus, according to the color copy machine 100 as the first embodiment, the deviation calculating section 51 of the whole control section 15 generates the deviation average value Ave for evaluating a condition of the sheet of paper P in the transporting section based on the stored deviation data D52 and generates the standard deviation Std of the deviations for evaluating a condition of the detection section based on the stored deviation data D52.

The discrimination section 55 compares the deviation average value Ave of the transported sheets of paper p generated by the deviation calculating section 51 with the deviation average allowable value Pr read out of the characteristics-data-storing section 53 and compares the standard deviation Std of the deviations of transported sheets of paper P generated by the deviation calculating section 51 with the reference standard deviation Ph of the deviations of transported sheets of paper P read out of the characteristics-data-storing section 53, thereby discriminating between a case in which there is malfunction on the sheet of paper P in the transporting section and a case in which there is malfunction in the detection section.

By this discrimination result, it is possible to correctly specify a case in which there is malfunction on the sheet of paper P in the transporting section (the feeding tray 291 or the like), for example, based on a poor adjustment of setting position thereof, or a case in which there is malfunction in the detection section (the deviation detection sensor 12A or the like), for example, based on an error detection thereof. Accordingly, the manipulation section 48 displays a warning, “Please check setting of feeding tray” when there is malfunction on the sheet of paper P in the transporting section or displays a warning, “Please check black color board of deviation detection sensor” when there is malfunction in the detection section. This enables the high reliable color copy machine 100 having a self-maintenance function to be provided.

### Second Embodiment

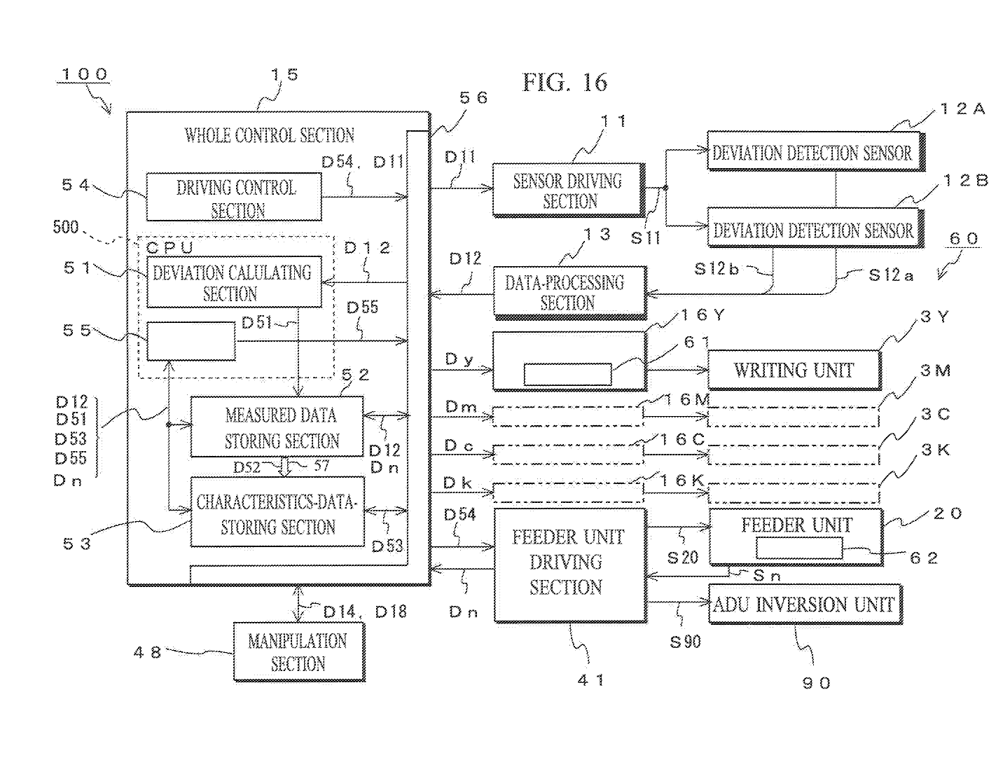

The following will describe a configuration example of a control section of a color copy machine 200 according to a second embodiment of this invention, with reference to FIG. 16. The second embodiment is different from the first embodiment in that a special data bus 57 is provided between the measured-data-storing section 52 and the characteristics-data-storing section 53. In FIG. 16, the special data bus 57 is shown by a space arrow.

In this second embodiment, by transmitting the stored deviation data D52 containing the deviation average value Ave of the transported sheets of paper P and the standard deviation Std of the deviations which are obtained in the step ST111 shown in FIG. 15 to the characteristics-data-storing section 53 through the special data bus 57, it is possible to change and/or update the deviation characteristics data D53. Providing with the special data bus 57 enables the stored deviation data D52 to be transmitted to the characteristics-data-storing section 53 without being burden to a control in the I/O interface 56 compared with the first embodiment.

Of course, the change and/or update of the deviation characteristics data D53 is not limited thereto: A user may manipulate the manipulation section 48 to input the deviation characteristics data D53 as shown in FIG. 13 directly into the characteristics-data-storing section 53 and change and/or update the deviation characteristics data D53, for example, a passing position [mm] of sheet of paper P based on transport center, a passing position [dot] of sheet of paper P based on a sensor, a maximum value Pmax [dot] of deviations, a standard deviation Ph [dot] of deviations and deviation average allowable value Pr [dot]. It is to be noted that other components and operations of the color copy machine 200 in this embodiment are identical to those of the color copy machine 100 of the first embodiment so that the identical components are indicated by the same reference numbers, a detailed explanation of which will be omitted.

Thus, according to the color copy machine 200 as the second embodiment, the special data, bus 57 connects the measured-data-storing section 52 and the characteristics-data-storing section 53 so that the stored deviation data D52 containing the deviation average value Ave of the transported sheets of paper P and the standard deviation. Std of the deviations is transmitted to the characteristics-data-storing section 53 through, the special data bus 57.

Such a configuration enables the deviation characteristics data D53 to be easily changed and/or updated, thereby allowing the high reliable color copy machine 200 having self-maintenance function, which can change the evaluation reference information, to be provided.

### Third Embodiment

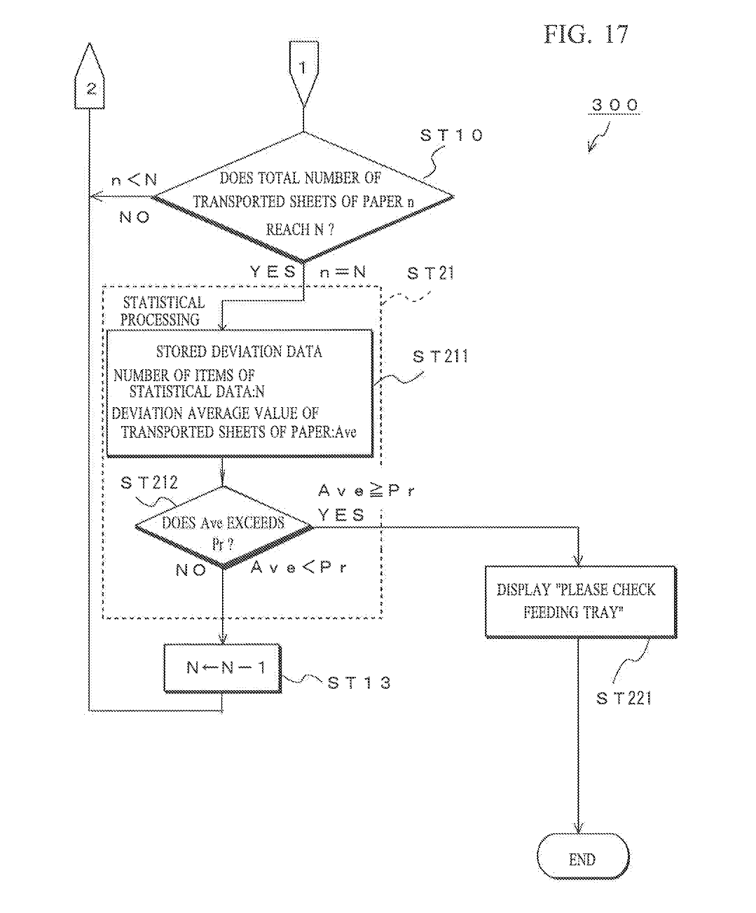

The following will describe an operation example of a color copy machine 300 according to a third embodiment of this invention when performing the statistical processing, with reference to FIG. 17. The third embodiment is different from the first embodiment in that the controls of the detection section are removed from an example of an operation of the color copy machine 100 according to the first embodiment when performing the statistical processing. In other words, only the controls of the transporting section are performed when performing the statistical processing, in the third embodiment. The control section of the color copy machine 100 according to the first embodiment as shown in FIG. 4 or the control section of the color copy machine 200 according to the second embodiment as shown in FIG. 16 is applied to the color copy machine 300.

It is to be noted that the controls of the steps up to the step ST10 of the flowchart shown in FIG. 17 are identical to those of the steps ST1 through ST10 of the flowchart shown in FIGS. 14 and 15 of the first embodiment so that a detailed explanation thereof will be omitted.

In this statistical processing at a step ST21, the deviation calculating section 51 outputs the stored deviation data D52 for evaluating the condition of the transporting section to the discrimination section 55. The characteristics-data-storing section 53 outputs the deviation characteristics data D53 to be compared with the stored deviation data D52 to the discrimination section 55.

In this embodiment, the deviation calculating section 51 calculates the deviation average value Ave of transported sheets of paper as the evaluation information. The deviation calculating section 51 calculates the deviation average value Ave according to the above-mentioned equation (1). The deviation average value Ave is used for specifying that there is malfunction on the sheet of paper in the transporting section.

At a step ST212, the discrimination section 55 compares the deviation average value Ave with the deviation average allowable value Pr to specify whether or not there is malfunction on the sheet of paper in the transporting section. If the deviation average value Ave exceeds the deviation average allowable value Pr (see FIG. 10B), i.e. Ave>=Pr, then the whole control section 15 goes to a step ST221 where the discrimination section 55 carries out any warning display processing.

On this warning display processing, at the step ST221, the discrimination section 55 controls the manipulation section 48 to display a warning, “Please check setting of feeding tray”. The manipulation section 48 displays a warning, “Please check setting of feeding tray” based on the display data D18 output from the whole control section 15.

If the deviation average value Ave does not exceed the deviation average allowable value Pr, i.e., Ave<Pr, at the step ST212, then the whole control section 15 goes to the step ST13. It is to be noted that the controls of the step ST13 and thereafter of the flowchart shown in FIG. 17 are identical to those of the first embodiment so that a detailed explanation thereof will be omitted.

Thus, according to the color copy machine 300 as the third embodiment, the deviation calculating section 51 of the whole control section 15 generates the deviation average value Ave for evaluating a condition of the sheet of paper in the transporting section based on the stored deviation data D52. The discrimination section 55 compares the deviation average value Ave of the transported sheets of paper P generated by the deviation calculating section 51 with the deviation average allowable value Pr read out of the characteristics-data-storing section 53 to determine whether or not there is malfunction on the sheet of paper P in the transporting section.

By this determination result, it is possible to correctly specify that there is malfunction on the sheet of paper P in the transporting section (feeding tray 291 or the like), for example, based on a poor adjustment of setting position thereof. Accordingly, the manipulation section 48 displays a warning, “Please check setting of feeding tray” when there is malfunction on the sheet of paper P in the transporting section. This enables the high reliable color copy machine 300 having a self-maintenance function to be provided.

### Fourth Embodiment

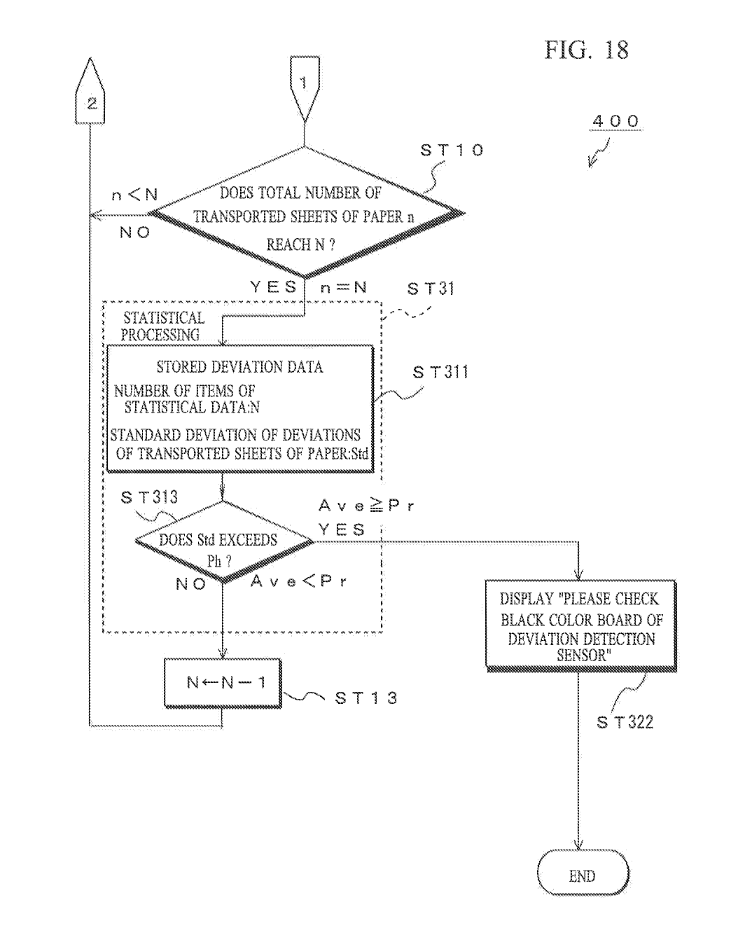

The following will describe an operation example of a color copy machine 400 according to a fourth embodiment of this invention when performing the statistical processing, with reference to FIG. 18. The fourth embodiment is different from the first embodiment in that the controls of the transporting section are removed from an example of an operation of the color copy machine 100 according to the first embodiment when performing the statistical processing. In other words, only the controls of the detection section are performed when performing the statistical processing, in the fourth embodiment. The control section of the color copy machine 100 according to the first embodiment as shown in FIG. 4 or the control section of the color copy machine 200 according to the second embodiment as shown in FIG. 16 is applied to the color copy machine 400.

It is to be noted that the controls of the steps up to the step ST10 of the flowchart shown in FIG. 18 are identical to those of the steps ST1 through ST10 of the flowchart, shown in FIGS. 14 and 15 of the first embodiment so that a detailed explanation thereof will be omitted.

In this statistical processing at a step ST31, the deviation calculating section 51 or the measured-data-storing section 52 outputs the stored deviation data D52 for evaluating the condition of the detection section to the discrimination section 55. The characteristics-data-storing section 53 outputs the deviation characteristics data D53 to be compared with the stored deviation data D52 to the discrimination section 55.

According to this statistical processing, at a step ST311 which is a subroutine of the step ST31, the whole control section 15 performs the statistical processing on the stored deviation data D52 of the transported sheets of paper P to generate evaluation information for evaluating the condition of the detection section. In this embodiment, the deviation calculating section 51 calculates the standard deviation Std of the deviations of transported sheets of paper as the evaluation information. The deviation calculating section 51 calculates the standard deviation Std of the deviations according to the above-mentioned equation (2). The standard deviation Std of the deviations is used for specifying that there is malfunction in the detection section.

At the step ST313, the discrimination section 55 compares the standard deviation Std of the deviations with, the reference standard deviation Ph of the deviations to specify whether or not there is malfunction in the detection section. If the standard deviation Std of the deviations exceeds the reference standard deviation Ph of the deviations (see FIGS. 6 and 7), i.e., Std>=Ph, then the whole control section 15 goes to a step ST322 where the whole control section 15 carries out any warning display processing.

At the step ST322, the whole control section 15 controls the manipulation section 48 to display a warning, “Please check black color board of deviation detection sensor”. The manipulation section 43 displays a warning, “Please check black color board, of deviation detection sensor” based, on display data D18 output from the whole control section 15.

If the standard deviation Std of the deviations does not exceed, the reference standard deviation Ph of the deviations at the step ST313, i.e., Std<Ph, then the whole control section 15 goes to the step ST13. It is to be noted that the controls of the step ST13 and thereafter of the flowchart shown in FIG. 18 are identical to those of the first embodiment so that a detailed explanation thereof will be omitted.

Thus, according to the color copy machine 400 as the fourth embodiment, the deviation calculating section 51 of the whole control section 15 generates the standard deviation Std of the deviations for evaluating a condition of the detection section based on the stored deviation data D52. The discrimination section 55 compares the standard deviation Std of the deviations of transported sheets of paper P generated by the deviation calculating section 51 with the reference standard deviation Ph of the deviations of transported sheets of paper F read out of the characteristics-data-storing section 53 to determine whether or not there is malfunction in the detection section.

By this determination result, it is possible to correctly specify that there is malfunction in the detection section (the deviation detection sensor 12A or the like), for example, based on an error detection thereof. Accordingly, the manipulation section 48 displays a warning, “Please check black color board of deviation detection sensor” when there is malfunction in the detection section. This enables the high reliable color copy machine 100 having self-maintenance function to be provided.

Although the cases in which there is malfunction on the sheet of paper P in the transporting section (feeder unit 20), for example, based on a poor adjustment of setting position thereof or there is malfunction in the detection section, for example, an error detection or the like based on a malfunction of the black color board 19 of the deviation detection sensor 12A when the simplex printing mode is set have been described in the above-mentioned first through fourth embodiments, the present invention is not limited to these embodiments. According to this invention, it is, of course, possible to specify that there is malfunction on the sheet of paper P in the transporting section (ADU inversion unit 90), for example, based on a poor adjustment of setting position thereof or there is malfunction in the detection section, for example, an error detection or the like based on a malfunction of the black color board 19 of the deviation detection sensor 12B when the duplex printing mode is set.

This invention is very suitably applicable to a monochrome or color printer, a copy machine, a multiple function machine and the like, which, are capable of reading any variations with time of the transporting section or the detection section and displaying a warning therefor.

Although the present invention has been described with reference to the embodiments above, it is to be noted that the present invention is not limited to the embodiments, and various changes and modifications are possible to those who are skilled in the art insofar as they are within the scope of the invention.

It should be understood by those skilled in the art that various combinations, sub-combinations and alterations may occur depending on design requirements and other factors insofar as they are within the scope of the appended claims or the equivalents thereof.

What is claimed is:

1. An image forming apparatus that forms an image on a sheet member, the apparatus comprising:
an image forming section which forms the image on the sheet member;
a transporting section which transports the sheet member to the image forming section;
a detection section which detects a passing position of transported sheet member on a direction that is perpendicular to a transporting direction of the sheet member and outputs information on the passing position for every transported sheet member;
an evaluation-information-generating section which generates evaluation information for evaluating a condition of the transporting section or the detection section by performing statistical processing on an amount of a deviation for every sheet member, the deviation being a difference between the passing position of the transported sheet member based on the information on the passing position output from the detection section and a transport reference position on the direction that is perpendicular to the transporting direction of the sheet member; and
a discrimination section configured to discriminate between a case in which there is malfunction in the transporting section and a case in which there is malfunction in the detection section by comparing the evaluation information generated in the evaluation-information-generating section with evaluation reference information that is a reference when discriminating between the case in which there is the malfunction in the transporting section and the case in which there is the malfunction in the detection section.

2. The image forming apparatus according to claim 1 wherein the evaluation information includes an average value which is obtained by averaging the amount of deviation for every sheet member and the evaluation reference information includes a reference value in relation to the average value which is obtained by averaging the amount of deviation for every sheet member.

3. The image forming apparatus according to claim 2 further comprising a warning section which warns the malfunction discriminated by the discrimination section, wherein the warning section warns that there is the malfunction in the transporting section when the average value which is obtained by averaging the amount of deviation for every sheet member exceeds the reference value.

4. The image forming apparatus according to claim 1 wherein the evaluation information includes a standard deviation value of the amount of deviation for every sheet member and the evaluation reference information includes a reference value in relation to the standard deviation value of the amount of deviation for every sheet member.

5. The image forming apparatus according to claim 4 further comprising a warning section which warns the malfunction discriminated by the discrimination section, wherein the warning section warns that there is the malfunction in the detection section when the standard deviation value of the amount of deviation for every sheet member exceeds the reference value.

6. The image forming apparatus according to claim 1 wherein the reference information includes different species of the reference information for every size of the sheet member, every kind of the sheet member or every paper weight of the sheet member.

7. The image forming apparatus according to claim 1 further comprising a correction section which corrects an image writing position in the image forming section, wherein the correction section corrects the image writing position in the image forming section when the amount of the deviation for every sheet member, the deviation being the difference between the passing position of the transported sheet member based on the information on the passing position output from the detection section and the transport reference position on the direction that is perpendicular to the transporting direction of the sheet member, stays within a permissible range of a correction operation by the correction section.
